(19) United States
(12) Patent Application Publication
(10) Pub. No.: US 2025/0110297 A1
(43) Pub. Date: Apr. 3, 2025

(54) Optical Module

(71) Applicant: HISENSE BROADBAND MULTIMEDIA TECHNOLOGIES CO., LTD., Qingdao (CN)

(72) Inventors: Tao WU, Qingdao (CN); Jianwei Mu, Qingdao (CN); Jin Hong, Qingdao (CN); Honghao Zhang, Qingdao (CN); Zhanpeng Zhang, Qingdao (CN); Aiwei Jing, Qingdao (CN); Tengfei Wang, Qingdao (CN); Chuanbin Li, Qingdao (CN); Rui Xu, Qingdao (CN)

(73) Assignee: HISENSE BROADBAND MULTIMEDIA TECHNOLOGIES CO., LTD., Qingdao (CN)

(21) Appl. No.: 18/621,699

(22) Filed: Mar. 29, 2024

Related U.S. Application Data
(63) Continuation of application No. PCT/CN2023/141848, filed on Dec. 26, 2023.

(30) Foreign Application Priority Data
Sep. 28, 2023 (CN) 202311271735.3
Dec. 21, 2023 (CN) 202311771298.1
Dec. 21, 2023 (CN) 202311771330.6
Dec. 21, 2023 (CN) 202311776059.5
Dec. 21, 2023 (CN) 202311776082.4

(51) Int. Cl. G02B 6/42

(52) U.S. Cl. CPC G02B 6/4249; G02B 6/4256; G02B 6/428; G02B 6/4246

(57) ABSTRACT

An optical module including an upper shell part, a circuit board, a base, and a light reception component and a light emission component respectively disposed on upper and lower surfaces of the base; a base mounting portion is formed on the surface of the circuit board, through which the base is secured to the circuit board. In order to increase heat dissipation effect of the base, a protrusion is formed on an upper surface of the base, which protrudes towards and is in thermal connection with the upper shell part, conducting heat through the base. To dissipate heat generated by the light emission component more effectively, the light emission component is disposed on a lower surface of the base. Heat dissipation effect of the base is improved by forming the protrusion on the upper surface of the base and using it as a heat dissipation protrusion.

### CROSS-REFERENCE TO RELATED APPLICATIONS

This disclosure is a continuation application of PCT/CN2023/141848 filed on Dec. 26, 2023, which claims priorities to Chinese patent applications No. 202311271735.3 filed on Sep. 28, 2023, No. 202311776059.5 filed on Dec. 21, 2023, No. 202311776082.4 filed on Dec. 21, 2023, No. 202311771298.1 filed on Dec. 21, 2023, and No. 202311771330.6 filed on Dec. 21, 2023 with the China National Intellectual Property Administration (CNIPA), the entire disclosures of which are incorporated herein by reference.

### FIELD OF THE INVENTION

This disclosure relates to the technical field of optical fiber communication technology, particularly to an optical module.

### BACKGROUND OF THE INVENTION

With the development of new business and application models such as cloud computing, mobile internet and video, the development and progress of optical communication technology has become increasingly important. Also, in optical communication technology, optical modules are tools for achieving mutual conversion between optical and electrical signals and are one of key devices in optical communication apparatus, and are placed at a core position in optical communication.

### SUMMARY OF THE INVENTION

This disclosure provides an optical module including an upper shell part, a circuit board formed with a base mounting portion on a surface thereof; a base secured to the surface of the circuit board via the base mounting portion; a light reception component; and a light emission component. Wherein, the base is formed, on an upper surface thereof, with a protrusion protruded towards the upper shell part and in thermal connection with the upper shell part; the light reception component is located on an upper surface of the base and at a side of the protrusion, to receive multi-path optical signals; and the light emission component is located on a lower surface of the base to emit multi-path optical signals.

### BRIEF DESCRIPTION OF THE DRAWINGS

In order to illustrate technical solutions disclosed in this disclosure more clearly, a brief description on the accompanying drawings required in some embodiments of this disclosure will be given below. It is obvious that the accompanying drawings described below are only those of some embodiments of this disclosure, and for those skilled in the art, other accompanying drawings can also be obtained based on these drawings. In addition, the accompanying drawings described below may be regarded as schematic diagrams and are not intend to limit actual size of the relevant products, actual process of the relevant methods, actual timing of signals or the like involved in the disclosed embodiments.

FIG. 1 is a partial architecture diagram of an optical communication system provided according to some embodiments of this disclosure;

FIG. 2 is a partial structural diagram of a master computer provided according to some embodiments of this disclosure;

FIG. 3 is a structural diagram of an optical module provided according to some embodiments of this disclosure;

FIG. 4 is an exploded diagram of an optical module provided according to some embodiments of this disclosure;

FIG. 5A is a first structural diagram of a first base provided according to some embodiments of this disclosure;

FIG. 5B is a second structural diagram of the first base provided according to some embodiments of this disclosure;

FIG. 5C is a structural diagram of a circuit board provided according to some embodiments of this disclosure;

FIG. 5D is a schematic assembly diagram of the first base and the circuit board provided according to some embodiments of this disclosure;

FIG. 6A is a first structural diagram of a second base provided according to some embodiments of this disclosure;

FIG. 6B is a second structural diagram of the second base provided according to some embodiments of this disclosure;

FIG. 6C is a schematic assembly diagram of the second base and the circuit board provided according to some embodiments of this disclosure;

FIG. 7A is a first structural diagram of a third base provided according to some embodiments of this disclosure;

FIG. 7B is a second structural diagram of the third base provided according to some embodiments of this disclosure;

FIG. 7C is a structural diagram of another circuit board provided according to some embodiments of this disclosure;

FIG. 7D is an assembly diagram of the third base and the circuit board provided according to some embodiments of this disclosure;

FIG. 8 is a structural diagram of a fourth base provided according to some embodiments of this disclosure;

FIG. 9 is a structural diagram of a fifth base provided according to some embodiments of this disclosure;

FIG. 10 is an assembly structural diagram of a light reception component provided according to some embodiments of this disclosure;

FIG. 11 is an exploded assembly diagram of a light reception component provided according to some embodiments of this disclosure;

FIG. 12 is a sectional structural diagram of a light reception component provided according to some embodiments of this disclosure;

FIG. 13 is a schematic diagram showing an electrical connection between a light reception chip and a transimpedance amplifier provided according to some embodiments of this disclosure;

FIG. 14 is a structural diagram of a light reception component provided according to some embodiments of this disclosure;

FIG. 15 is an exploded diagram of a light reception component provided according to some embodiments of this disclosure;

FIG. 16 is a structural diagram of a lens assembly provided according to some embodiments of this disclosure;

FIG. 17 is a schematic assembly diagram of another light reception component provided according to some embodiments of this disclosure;

FIG. 18 is a structural schematic diagram of another light reception component provided according to some embodiments of this disclosure;

FIG. 19 is an exploded schematic diagram of another light reception component provided according to some embodiments of this disclosure;

FIG. 20 is an assembly structural diagram of yet another light reception component provided according to some embodiments of this disclosure;

FIG. 21 is a structural schematic diagram of yet another light reception component provided according to some embodiments of this disclosure;

FIG. 22 is an exploded schematic diagram of yet another light reception component provided according to some embodiments of this disclosure;

FIG. 23 is a top structural diagram of yet another light reception component provided according to some embodiments of this disclosure;

FIG. 24 is a structural schematic diagram of yet another light reception component provided according to some embodiments of this disclosure;

FIG. 25 is an exploded schematic diagram of yet another light reception component provided according to some embodiments of this disclosure;

FIG. 26 is a top schematic diagram of yet another light reception component provided according to some embodiments of this disclosure;

FIG. 27 is a schematic assembly diagram of yet another light reception component provided according to some embodiments of this disclosure;

FIG. 28 is a structural schematic diagram of yet another light reception component provided according to some embodiments of this disclosure;

FIG. 29 is a schematic assembly diagram of another light reception component provided according to some embodiments of this disclosure;

FIG. 30 is a structural schematic diagram of yet another light reception component provided according to some embodiments of this disclosure;

FIG. 31 is a schematic assembly diagram of a light emission component provided according to some embodiments of this disclosure;

FIG. 32 is a top assembly diagram of a light emission component provided according to some embodiments of this disclosure;

FIG. 33 is an exploded assembly diagram of a light emission component provided according to some embodiments of this disclosure;

FIG. 34 is a structural diagram of a second protection cover of a light emission component provided according to some embodiments of this disclosure;

FIG. 35 is a side assembly view of a light emission component provided according to some embodiments of this disclosure;

FIG. 36 is an exploded side assembly diagram of a light emission component provided according to some embodiments of this disclosure;

FIG. 37 is a sectional structural diagram of a light emission component provided according to some embodiments of this disclosure;

FIG. 38 is an exploded structural diagram of a light emission component provided according to some embodiments of this disclosure;

FIG. 39 is a sectional assembly diagram of another light emission component provided according to some embodiments of this disclosure;

FIG. 40 is a schematic assembly diagram of another light emission component provided according to some embodiments of this disclosure;

FIG. 41 is a structural schematic diagram of another light emission component provided according to some embodiments of this disclosure;

FIG. 42 is a sectional structural diagram of another light emission component provided according to some embodiments of this disclosure;

FIG. 43 is a first structural schematic diagram showing a local section of an optical module provided according to some embodiments of this application;

FIG. 44 is a second structural schematic diagram showing a local section of an optical module provided according to some embodiments of this application;

FIG. 45 is a first schematic assembly diagram of yet another light emission component provided according to some embodiments of this disclosure;

FIG. 46 is a second schematic assembly diagram of yet another optical emission component provided according to some embodiments of this disclosure; and

FIG. 47 is a structural schematic diagram of yet another light emission component provided according to some embodiments of this disclosure.

### DETAILED DESCRIPTION OF THE EMBODIMENTS

Some embodiments of this disclosure will be described clearly and completely with reference to the accompanying drawings below. Apparently, these embodiments are merely some, but not all, of the embodiments of this disclosure. All other embodiments obtained by a person of ordinary skill in the art based on the embodiments of this disclosure shall fall within the protection scope of this disclosure.

Optical communication technology may establish information transmission between information processing devices. Optical communication technology is used to load information onto light, and transmission of the information is achieved through propagation of light. The light loaded with information is namely an optical signal. The optical signal is propagated in the information transmission devices, which may reduce loss of optical power and achieve high-speed, long-distance, and low-cost information transmission. The information that may be processed by the information processing device exists in a form of electrical signals. Optical network terminals/gateways, routers, switches, mobile phones, computers, servers, tablets, and televisions are common information processing device, while optical fibers and waveguides are common information transmission device.

Conversion of optical and electrical signals between the information processing device and the information transmission device is achieved through optical modules. For example, an optical fiber may be connected to an optical signal input and/or output terminal of an optical module, and an optical network terminal may be connected to an electrical signal input and/or output terminal of the optical module; a first optical signal from the optical fiber is transmitted into the optical module, which converts the first optical signal into a first electrical signal, and then transmits the first electrical signal to the optical network terminal; a second electrical signal from the optical network terminal is transmitted into the optical module, which converts the second electrical signal into a second optical signal, and then transmits the second optical signal into the optical fiber. Since information processing devices may be connected to each other via an electrical signal network, at least one type of information processing device needs to be directly connected to the optical module, and it is unnecessary for all types of information processing devices to be directly connected to the optical module. The information processing device directly connected to the optical module is called as a master computer of the optical module.

FIG. 1 is a partial architecture diagram of an optical communication system provided according to some embodiments of this disclosure. As shown in FIG. 1, the optical communication system is partially presented as including a remote information processing device 1000, a local information processing device 2000, a master computer 100, an optical module 200, an optical fiber 101, and a network cable 103.

One end of the optical fiber 101 extends towards the remote information processing device 1000, while the other end thereof is coupled to an optical interface of the optical module 200. An optical signal may undergo a total reflection in the optical fiber 101, and propagation of the optical signal in a total reflection direction can almost maintain the original optical power. The optical signal undergoes multiple total reflections in the optical fiber 101, such that the optical signal from the remote information processing device 1000 is transmitted into the optical module 200, or the light from the optical module 200 is propagated towards the remote information processing device 1000, thereby achieving long-distance information transmission with low power loss.

There may be one or multiple (two or more) optical fiber 101. The optical fiber 101 may be connected to the optical module 200 in a pluggable and removable connection manner or a fixed connection manner.

The master computer 100 has an optical module interface 102, which is configured to be coupled to the optical module 200, thereby establishing a unidirectional/bidirectional electrical signal connection between the master computer 100 and the optical module 200. The master computer 100 is configured to provide data signals to the optical module 200, receive data signals from the optical module 200, or monitor and control working status of the optical module 200.

The master computer 100 has an external electrical interface, such as a Universal Serial Bus (USB) or a network cable interface 104, which may be coupled to the electrical signal network. For example, the network cable interface 104 is configured to be coupled by the network cable 103, thereby establishing a unidirectional/bidirectional electrical signal connection between the master computer 100 and the network cable 103.

Optical Network Unit (ONU), Optical Line Terminal (OLT), Optical Network Terminal (ONT), and Data Center Server are common master computers.

One end of the network cable 103 is connected to the local information processing device 2000, and the other end thereof is connected to the master computer 100. The network cable 103 establishes an electrical signal connection between the local information processing device 2000 and the master computer 100.

For example, a third electrical signal emitted by the local information processing device 2000 is transmitted to the master computer 100 through the network cable 103. The master computer 100 generates a second electrical signal based on the third electrical signal, and the second electrical signal from the master computer 100 is transmitted to the optical module 200. The optical module 200 converts the second electrical signal into a second optical signal, and transmits the second optical signal into the optical fiber 101. The second optical signal is transmitted to the remote information processing device 1000 through the optical fiber 101.

For example, a first optical signal from the remote information processing device 1000 is propagated through the optical fiber 101. The first optical signal from the optical fiber 101 is transmitted into the optical module 200. The optical module 200 converts the first optical signal into a first electrical signal, and transmits the first electrical signal to the master computer 100. The master computer generates a fourth electrical signal based on the first electrical signal, and transmits the fourth electrical signal into the local information processing device 2000.

The optical module is a tool for achieving the conversion between optical and electrical signals. During the conversion between optical and electrical signals as described above, the information is not changed, but methods for encoding and decoding the information may be changed.

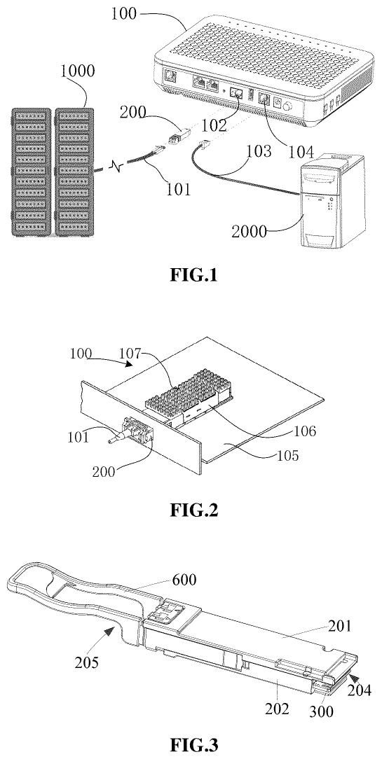

FIG. 2 is a partial structural diagram of a master computer according to some embodiments of this disclosure. In order to illustrate a connection relationship between the optical module 200 and the master computer 100 clearly, FIG. 2 only shows the structure of the master computer 100 related to the optical module 200. As shown in FIG. 2, the master computer 100 further includes a PCB circuit board 105 disposed within a shell, a cage 106 disposed on a surface of the PCB circuit board 105, a radiator 107 disposed on the cage 106, and an electrical connector (not shown in the Figure) disposed inside the cage 106. The radiator 107 has a raised structure that increases a heat dissipation area. A fin structure is a common raised structure.

The optical module 200 is inserted into the cage 106 of the master computer 100 and then is secured by the cage 106. Thus, heat generated by the optical module 200 is conducted to the cage 106, and then dissipated via the radiator 107. After the optical module 200 is inserted into the cage 106, an electrical interface of the optical module 200 is connected to the electrical connector inside the cage 106.

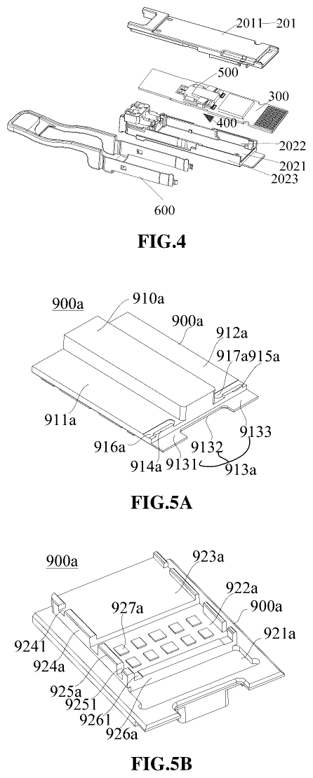

FIG. 3 is a structural diagram of an optical module according to some embodiments of this disclosure, and FIG. 4 is an exploded diagram of an optical module according to some embodiments of this disclosure. As shown in FIG. 3 and FIG. 4, the optical module 200 includes a shell, and a circuit board 300, a light emission component 400 and a light reception component 500 that are disposed within the shell. However, this disclosure is not limited to this. In some embodiments, the optical module 200 may include one of the light emission component 400 and the light reception component 500.

The shell may include an upper shell part 201 and a lower shell part 202. The upper shell part 201 is covered on the lower shell part 202 to form the aforementioned shell having two openings 204 and 205. An outer contour of the shell is generally in a cuboid shape.

In some embodiments, the lower shell part 202 includes a bottom plate 2021 and two lower side plates located at opposite sides of the bottom plate 2021 and disposed perpendicular to the bottom plate 2021, and the upper shell part 201 includes a cover plate 2011. The cover plate 2011 covers on the two lower side plates of the low shell part 202 so as to form the above-mentioned shell.

In some embodiments, the lower shell part 202 includes a bottom plate 2021 and a first lower side plate 2022 and a second lower side plate 2023 located on opposite sides of the bottom plate 2021 and disposed perpendicular to the bottom plate 2021; the upper shell part 201 includes a cover plate 2011 and two upper side plates located on opposite sides of the cover plate 2011 and disposed perpendicular to the cover plate 2011, and the two upper side plates are combined with the two lower side plates such that the upper shell part 201 is covered on the lower shell part 202.

A direction along a connecting line between the two openings 204 and 205 may be consistent with a length direction of the optical module 200 or inconsistent with the length direction of the optical module 200. For example, the opening 204 is located at an end of the optical module 200 (right end in FIG. 3), and the opening 205 is also located at an end of the optical module 200 (left end in FIG. 3). Alternatively, the opening 204 is located at an end of the optical module 200, while the opening 205 is located at a side of the optical module 200. The opening 204 is an electrical interface, and a golden finger of the circuit board 300 extends out of the electrical interface and is inserted into the electrical connector of the master computer. The opening 205 is an optical port configured to be coupled by the optical fiber 101 such that the optical fiber 101 is connected with the light emission component 400 and/or the light reception component 500 of the optical module 200.

The assembling way in which the upper shell part 201 is combined with the lower shell part 202 facilitates mounting the circuit board 300, the light emission component 400, the light reception component 500 or the like into the above-mentioned shell, such that these components is encapsulated and protected by the upper shell part 201 and the lower shell part 202.

In addition, when assembling the circuit board 300, the light emission component 400, the light reception component 500 or the like, it is easier to deploy positioning elements, heat dissipation elements, and electromagnetic shielding elements of these components, which facilitates automate production implementation. In some embodiments, the upper shell part 201 and the lower shell part 202 are made of metal material(s), which facilitates to achieving electromagnetic shielding and heat dissipation.

In some embodiments, the optical module 200 further includes an unlocking component 600 located outside the shell thereof. The unlocking component 600 is configured to achieve a fixed connection between the optical module 200 and the master computer or to release the fixed connection between the optical module 200 and the master computer.

For example, the unlocking component 600 is located outside the two lower side plates 2022 of the lower shell part 202, and includes a snaping part that matches with the cage 106 of the master computer. When the optical module 200 is inserted into the cage 106, the snaping part of the unlocking component 600 secures the optical module 200 within the cage 106. As the unlocking component 600 is pulled, the snaping part of the unlocking component 600 moves accordingly, and thus the connection relationship between the snaping part and the master computer is changed, thereby releasing the snaping connection between the optical module 200 and the master computer, such that the optical module 200 can be drawn out of the cage 106.

The circuit board 300 includes circuit wiring, electronic elements, chips and so on. The electronic elements and chips are connected together via the circuit wiring according to a circuit design so as to achieve various functions such as power supply, electrical signal transmission, and grounding. For example, the electronic elements may include capacitors, resistors, transistors, and Metal-Oxide-Semiconductor Field-Effect Transistors (MOSFETs). For example, the chips may include microcontroller units (MCUs), laser driver chips, transimpedance amplifiers (TIAs), limiting amplifiers, Clock and Data Recovery (CDR) chips, power management chips, and digital signal processing (DSP) chips.

The circuit board 300 is generally a rigid circuit board. Also, the rigid circuit board may achieve a carrying function due to a relatively hard material thereof. For example, the rigid circuit board may steadily carry the above-mentioned electronic elements and chips thereon. Furthermore, the rigid circuit board may be easily inserted into the electrical connector inside the cage of the master computer.

The circuit board 300 further includes a gold finger formed on a surface of an end thereof, which is composed of multiple pins. The circuit board 300 is inserted into the cage 106 and is conductively connected to the electrical connector disposed inside the cage 106 via the golden finger. The golden finger may be disposed only on one surface of the circuit board 300 (e.g., an upper surface shown in FIG. 4), or on both upper and lower surfaces of the circuit board 300 to provide a larger number of pins. The golden finger is configured to establish an electrical connection with the master computer to achieve power supply, grounding, Inter-Integrated Circuit (I2C) signal transmission, data signal transmission or the like.

Of course, it is possible to use a flexible circuit board in some optical modules. The flexible circuit board is generally used in cooperation with the rigid circuit board to serve as a supplement to the rigid circuit board.

The light emission component 400 and/or the light reception component 500 are located on the side of the circuit board 300 away from the golden finger. In some embodiments, the light emission component 400 and the light reception component 500 each are physically separated from the circuit board 300, and then electrically connected to the circuit board 300 via the respective flexible circuit board or electrical connector. In some embodiments, the light emission component and/or the light reception component may be directly disposed on the circuit board 300, and may be disposed on a surface of the circuit board or on a lateral side of the circuit board. In some embodiments, the light emission component 400 and the light reception component 500 are located on the upper and lower surfaces of the circuit board, respectively.

In order to fully utilize a limited space, the existing 800G QSFPDD 2×FR4 mainly adopts a hard connection, that is, the light emission component 400 and the light reception component 500 are connected to an optical fiber adapter. In OSFQ packaging, the light emission component 400 and the light reception component 500 are firstly connected with the optical fiber, and then the optical fiber is connected with the optical fiber adapter at the optical port. This application provides an optical module in which the light emission component 400 and the light reception component 500 are disposed on opposite sides of a base embedded into the circuit board, and are coupled to the optical fiber, and then a soft connection is achieved by coupling the optical fiber to the optical port of the optical module. With this design, the same optical path and modular structure design may be applied to both QSFP-DD packaging and OSFP packaging, with meeting requirements of FR4 and LR4 optical modules on loss and sensitivity. This structure achieves an optical design for both the emission and reception ends and integrates different product packaging platforms (such as QSFP-DD and OSFP) and product standards (FR4 and LR4) into one and the same optical and structural design, thereby simplifying the assembly process, reducing material and component costs, and making it easier to achieve mass-production and low-cost goals. By appropriately arranging optical components and optimizing the assembly process, the overall assembly of module is greatly simplified, and production and maintenance efficiency are greatly improved, thereby making it more suitable for mass production.

In this disclosure, the optical module includes a base. The circuit board 300 is formed with a base mounting portion on a surface thereof. For example, a structure for the base mounting portion may be an opening, and other structures are also possible. The base is embedded in the base mounting portion so as to secure the base to the surface of the circuit board 300. In some embodiments, one surface of the base is used to carry the light reception component, and another surface is used to carry the light emission component, such that the light reception component and the light emission component are arranged in layers on the same structural unit, achieving a reasonable layout of optical components. In this disclosure, the light reception component and the light emission component are arranged on different surfaces of the same base, and multiple sets of light reception components or multiple sets of light emission components are arranged on the same surface of the base to achieve a multi-path reception and emission of the optical module (e.g. 1.6T optical module), which improves the transmission rate of the optical module.

In this disclosure, a heat dissipation duct may be formed between the upper shell part 201 of the optical module and the cage 106 of the master computer 100, so that the upper shell part 201 has a better heat dissipation effect than the lower shell part 202. Since a large amount of heat is generated by the light emission component, it is necessary to conduct the generated heat outside to ensure normal operation of the light emission component. In some embodiments, when the light emission component is disposed on the lower surface of the base, the heat generated by the light emission component is transferred upwards to the surface of the base, and then continues being transferred upwards to the upper shell part 201 via a thermal conductive connection between the base and the upper shell part 201, thereby dissipating the heat through the upper shell part 201. In some embodiments, when the light emission component is disposed on the upper surface of the base, heat generated by the light emission component is transferred downwards to the surface of the base, and then continues being transferred upwards to the upper shell part 201 via thermal conductive connection between the base and the upper shell part 201, thereby dissipating the heat through the upper shell part 201. In comparison, a heat dissipation path provided in the case of disposing the light emission component on the lower surface of the base is smoother than that provided in the case of disposing the light emission component on the upper surface of the base. Therefore, in this disclosure, the light emission component is disposed on the lower surface of the base, and the light reception component is disposed on the upper surface of the base.

In this disclosure, in order to achieve the thermal conductive connection between the base and the upper shell part 201, the upper surface of the base may be protruded upwards to form a protrusion, which is a heat dissipation boss. The thermal conductive connection between the protrusion and the upper shell part 201 may be realized through a thermal conductive gel or a thermal conductive pad, and a larger spreading surface provided by the protrusion may increase thermal conductive area between the base and the upper shell part 201, thereby improving the heat dissipation effect. In some embodiments, the light reception component is located at one side of the protrusion. For example, light reception components are provided on both sides of the protrusion, and the surface where the protrusion is located protrudes relative to the surface supporting the light reception component.

In this disclosure, the circuit board 300 is formed with a base mounting portion on a surface thereof, via which the base is secured to the surface of the circuit board. For example, a structure for the base mounting portion may be an opening, and other structures are also possible. The base is embedded in the base mounting portion so as to secure the base to the surface of the circuit board 300. In some embodiments, a size of the base in a width direction of the circuit board 300 may be larger than that of the base mounting portion, such that surfaces at opposite sides of the base mounting portion may support the base, and thus secure the base to the surface of the circuit board 300.

In this disclosure, in order to achieve multi-path optical signal emissions, the optical emission component may emit multi-path optical signals. In some embodiments, when emitting multi-path optical signals, the multi-path optical signals may be emitted separately rather than being combined into a single optical signal beam for emission. For example, the multi-path optical signals may be emitted separately via an optical fiber array, and a laser has a corresponding optical fiber strip for transmitting the optical signals. In some embodiments, when emitting multi-path optical signals, the multi-path optical signals may be combined into a single optical signal beam for emission. For example, the combination of the optical signals may be achieved via an optical multiplexing component. For example, the combination of the optical signals may be achieved by a combination of different filter sheets. By utilizing transmission and reflection characteristics of the filter sheets for specific wavelengths, it is possible to use a combination of multiple filter sheets to achieve the combination of optical signals. For example, the combination of the optical signals may be also achieved through devices (e.g., polarizers) with different polarization states. By utilizing different transmission characteristics of the devices with polarization states for light with different polarization directions, it is possible to use a combination of multiple polarizers to achieve the combination of optical signals. For example, the combination of the optical signals may be also achieved with a combination of filter and polarizer.

In this disclosure, in order to achieve reception of multi-path optical signals, the light reception component may include multiple photodetectors to receive multi-path optical signals. In some embodiments, the multi-path optical signals may be received via an optical fiber array, and then the optical paths of them may be turned with light path turning device(s) (that is, a device capable of changing or turning the light path), such that the multi-path optical signals may be transmitted separately to the multiple photodetectors. In other embodiments, for the turning of the optical paths, it is possible to grind an end face of the optical fiber to form a reflective surface, thereby achieving turning or changing of the optical path. For example, in the case of grinding the end face of the optical fiber to form the reflective surface, since the optical fiber is soft, it may be clamped from above and below. At this time, the optical fiber may be protruded or not. If the optical fiber is protruded, the end face of the optical fiber may be ground alone. If the optical fiber is not protruded, the end face of the optical fiber may be ground together with upper and lower clamping structures. In some embodiments, one path of received optical signal may be decomposed into multiple paths of optical signals via an optical demultiplexing component, and then optical paths of them may be turned with optical path turning device(s), thereby transmitting the multi-path optical signals to the multiple photodetectors, respectively. In some embodiments, the one path of received optical signal may be decomposed into multiple paths of optical signals via an Arrayed Waveguide Grating (AWG), and then the optical paths of them may be turned, thereby transmitting the multi-path optical signals to the photodetectors, respectively, during which multiplexed signal lights having multiple wavelengths in the AWG are output through a central input channel waveguide, and then undergo diffraction in an input planar waveguide, and reach an input concave grating for power distribution, and are coupled into an arrayed waveguide region. Since an end face of the arrayed waveguide is located on the circumference of the grating circle, the diffracted lights reach the end face of the arrayed waveguide at the same phase. After being transmitted through the arrayed waveguide, output lights of adjacent arrayed waveguides that have a specific wavelength will have the same phase difference on the output concave grating since the adjacent arrayed waveguides maintain the same length difference AL. For lights having different wavelengths, the phase difference is different. Therefore, lights having different wavelengths undergo diffraction in the output planar waveguide and focus on different positions of the output channel waveguide, and are output through the output channel waveguide, thereby completing wavelength allocating (i.e. demultiplexing) function.

In this disclosure, the multiple optical signals are emitted separately through the optical fiber array, the laser has a corresponding optical fiber strip for transmitting the optical signals, and the multi-path optical signals are received through the optical fiber array. Since the light emission component is located on the lower surface of the base and the light reception component is located on the upper surface of the base, the optical fiber array for the light emission component is located below the base and the circuit board 300 and the optical fiber array for the light reception component is located above the base and the circuit board 300.

In some embodiments of this disclosure, bases having different configurations are provided, and optical components having different structural combinations are provided, so as to configure optical modules having different structures. FIG. 5A is a first structural diagram of a first base provided according to some embodiments of this disclosure, and FIG. 5B is a second structural diagram of a first base provided according to some embodiments of this disclosure. As shown in FIG. 5A and FIG. 5B, in some embodiments, the light reception component and the light emission component are arranged on different surfaces of the same base, where the base may be a base 900a.

FIG. 5A shows a structure of one surface of the base 900a. As shown in FIG. 5A, in some embodiments, the light reception component and the light emission component are disposed on different surfaces of the base 900a. The surface shown in FIG. 5A is considered as an upper surface of the base 900a, and its opposite surface is considered as a lower surface of the base 900a. For example, the upper surface of the base 900a is configured to carry the light reception component, and the lower surface of the base 900a is configured to carry the light emission component. Wherein, the light reception component includes a light reception passive device, through which externally transmitted optical signals are received, and the optical signals are transmitted into the light reception component. For example, the light reception passive device may be an optical fiber array, an optical demultiplexing component, an AWG, or the like. FIG. 5A shows the structure of the upper surface of the base 900a.

Since the light emission component is located on the lower surface of the base 900a and a larger amount of heat is generated by the light emission component, in order to achieve heat dissipation of the light emission component, the surface of the base 900a may be protruded upwards to form a protrusion 910a. For example, a surface at the middle portion of the base 900a is protruded upwards to form the protrusion 910a, while surfaces at both sides do not protrude upwards but form a first carrying surface 911a and a second carrying surface 912a, respectively. Then, the upper surface of the base 900a is divided into the protrusion 910a and the first carrying surface 911a and second carrying surface 912a located at opposite sides of the protrusion 910a, respectively. With contact of the protrusion 910a with the upper shell part, heat generated by the light emission component is transferred to the outside of the light module, thereby achieving better heat dissipation. In order to achieve a multi-path reception, a first light reception passive device is disposed on the first carrying surface 911a, and a second light reception passive device is disposed on the second carrying surface 912a.

In some embodiments, the light reception component further includes a light reception chip disposed on a surface of the circuit board. A photosensitive surface of the light reception chip is parallel to the surface of the circuit board, and a transmission direction of optical signal received by the light reception passive device is parallel to the surface of the circuit board. Therefore, an optical path turning device is provided in a light exiting direction of the light reception passive device, to turn the optical signal towards a direction perpendicular to the surface of the circuit board. For example, the optical path turning device may be a turning prism, through which the optical signal is turned to be perpendicular to the surface of the circuit board, thereby transmitting the optical signal to the light reception chip.

The base 900a is also formed with an extension 913a, which is extended from the first carrying surface 911a and the second carrying surface 912a. The extension 913a is configured to carry the optical path turning device. For example, the optical path turning device may be a turning prism. In order to make way for electrical elements on the surface of the circuit board while corresponding to the light reception passive devices, the extension 913a includes a first extension portion 9131, a second extension portion 9133, and a notch 9132 located between the first extension portion 9131 and the second extension portion 9133. Wherein, the notch 9132 is configured to make way for the electrical elements (e.g., a resistor or a capacitor) on the circuit board; the first extension portion 9131 is located at an end of the first carrying surface 911a, for mounting a first optical path turning device corresponding to the first light reception passive device; and the second extension portion 9133 is located at an end of the second carrying surface 912a, for mounting a second optical path turning device corresponding to the second light reception passive device. The first extension portion 9131 is disposed at a position in a light exiting direction of the first light reception passive device and is extended from the first carrying surface 911a; and the second extension portion 9133 is disposed at a position in a light exiting direction of the second light reception passive device and is extended from second carrying surface 912a. Since the light reception chip array is disposed on the surface of the circuit board, and light reception surface (that is, photosensitive surface) of the light reception chip array is parallel to the surface of the circuit board, it is necessary to provide a first optical path turning device and a second optical path turning device so as to change transmission directions of multi-path optical signals output from the first light reception passive device such that the multi-path optical signals are transmitted to the light reception chip array, and change transmission directions of multi-path optical signals output from the second light reception passive device such that the multi-path optical signals are transmitted to the light reception chip array. For example, the first light reception passive device and the second light reception passive device may be a first optical fiber array and a second optical fiber array, respectively. In order to achieve matching of optical path, surfaces of the first extension portion 9131 and second extension portion 9133 are lower than those of the first carrying surface 911a and second carrying surface 912a, respectively.

In some embodiments, in order to limit the light reception passive device, a limiting tab is formed between the corresponding extension portion and carrying surface. For example, a first limiting tab 914a is formed between the first extension portion 9131 and the first carrying surface 911a, and a second limiting tab 915a is formed between the second extension portion 9133 and the second carrying surface 912a. A surface of the first limiting tab 914a is higher relative to a surface of the first carrying surface 911a so as to limit the first light reception passive device in a first direction. A surface of the second limiting tab 915a is higher relative to a surface of the second carrying surface 912a so as to limit the second light reception passive device in the first direction. A width of the first limit tab 914a is the same as a width of the first light reception passive device, and a width of the second limit tab 915a is the same as a width of the second light reception passive device, so as to limit the first light reception passive device and the second light reception passive device in a second direction, respectively. For example, the first direction may be in a length direction of the protrusion 910a, and the second direction may be in a width direction of the protrusion 910a.

In some embodiments, since the surface of the first limiting tab 914a is higher than the surface of the first carrying surface 911a, and the surface of the second limiting tab 915a is higher than the surface of the second carrying surface 912a, a chamfer will be formed at a junction of each limiting tab and its corresponding carrying surface during processing of the base. When mounting the light reception passive device, the presence of the chamfer would cause an end of the corresponding light reception passive device to be raised at the chamfer, resulting in uneven attaching of the light reception passive device and thus reducing stability of the reception optical path. Therefore, a first depression 916a is formed at the junction of the first limiting tab 914a and the first carrying surface 911a, and a second depression 917a is formed at the junction of the second limiting tab 915a and the second carrying surface 912a. The first depression 916a is provided so as to enable the end of the first light reception passive device to horizontally abut against a wall surface of the first limiting tab 914a, ensuring a smooth mounting of the first light reception passive device. Similarly, the second depression 917a is provided so as to enable an end face of the second light reception passive device to horizontally abut against a wall surface of the second limiting tab 915a, thereby ensuring a smooth mounting of the second light reception passive device. For example, the surface of the first depression 916a gradually tilts towards the wall surface of the first limiting tab 914a, and the surface of the second depression 917a gradually tilts towards the wall surface of the second limiting tab 915a, such that surfaces of ends of the first depression 916a and second depression 917a near the corresponding limiting tabs are concave, to avoid interference with the corresponding light reception passive devices and ensure smooth mounting of the light reception passive devices, thereby ensuring stability of the reception optical paths.

FIG. 5B shows a structure of the other surface of the base 900a. Specifically, FIG. 5B shows a structure of the lower surface of the base 900a. As shown in FIG. 5B, in some embodiments, the lower surface of the base 900a is formed with a third carrying surface 921a, a fourth carrying surface 922a, and a fifth carrying surface 923a. For example, the third carrying surface 921a is configured to mount a laser group of the optical emission component, with a TEC disposed below the laser group. The TEC and the laser group are stacked and thus have a height, the third carrying surface 921a is thus recessed such that the laser group is sinked to be flush with the surface of the circuit board 300, thereby ensuring that a wire bonding length between the laser group and the surface of the circuit board 300 is short. The fourth carrying surface 922a is configured to carry a light emission passive device. For example, the light emission passive device may be an optical fiber array, an optical multiplexing component, or the like. In a case that the light emission passive device is an optical fiber array, the surface of the fifth carrying surface 923a is configured for a fiber pigtail.

In some embodiments, in order to protect the light emission component, a protective cover may be provided on the lower surface of the base 900a. When the light emission passive device is the optical fiber array, in order to avoid any interference caused by the protective cover pressing onto the surface of the optical fiber, first supporting portions 924a are formed at both sides of the fifth carrying surface 923a, and second supporting portions 925a may also be formed at both sides of the fourth carrying surface 922a, to support the protective cover at a height, such that an inner wall of the protective cover and the optical fiber are spaced at a distance. In this disclosure, the protective cover may be support at a height by use of the first support portions 924a and the second support portions 925a, such that there is a space between the protective cover and the optical fiber, thereby avoiding their interference with each other.

In order to secure the protective cover to the base 900a, each of the first support portions 924a at both sides is formed, on its surface, with a receiving portion 9241, and the protective cover may be embedded in the receiving portion 9241, thereby securing the protective cover to the base 900a. Of course, it is also possible to use other structures for securing the protective cover.

In some embodiments, isolators are provided to prevent optical signals emitted by the laser group from returning to the laser group and affecting the quality of the optical signals. For example, the isolators are disposed between the light emission passive devices and the laser group. Accordingly, in order to mount the isolators, a sixth carrying surface 926a is formed between the fourth carrying surface 922a and the third carrying surface 921a. The sixth carrying surface 926a is provided to mount the isolators.

In some embodiments, in order to achieve matching of optical paths, a surface of the sixth carrying surface 926a is higher than that of the fourth carrying surface 922a. Therefore, during machining of the base, a chamfer will be formed at a junction of the sixth carrying surface 926a and the fourth carrying surface 922a. When attaching the light emission passive device, the presence of the chamfer would cause an end of the light emission passive device to be raised at the chamfer, resulting in uneven attaching of the light emission passive device and thus reducing stability of the emission optical path. Therefore, a notch 9251 is formed at an end of the second support portion 925a adjacent to the sixth carrying surface 926a. The notch 9251 is provided so as to enable an end of the light emission passive device to horizontally abut against a wall surface of the sixth carrying surface 926a, thereby ensuring a smooth mounting of the light emission passive device and the stability of the emission optical path.

In some embodiments, the light emission passive device (e.g., the optical fiber array) may be mounted on the fourth carrier surface 922a through adhesive. The bottom surface of the light emission passive device (e.g., the optical fiber array) would get fracture if a stress generated during adhesive bonding is too concentrated. In order to avoid stress concentration, protrusions 927a are formed at intervals on the surface of the fourth carrying surface 922a. The protrusions 927a are disposed at intervals so as to disperse the stress generated by the adhesive, thereby avoiding excessive concentration of the stress generated by the adhesive and ensuring undamaged mounting of the light emission passive device (e.g., the optical fiber array).

As mentioned above, in order to achieve the matching of the optical paths, the surface of the sixth carrying surface 926a is higher than that of the fourth carrying surface 922a, which can also limit the light emission passive device (e.g., optical fiber array) in a first direction.

In order to limit the light emission passive device (e.g., optical fiber array) in a second direction, surfaces of the sixth carrying surface 926a at both sides thereof may be recessed downwards to form grooves 9261, such that a width of a protruding surface portion of the sixth carrying surface 926a is same as a width of the light emission passive device (e.g., optical fiber array), thereby limiting the light emission passive device in the second direction. For example, the first direction may be the length direction of the protrusion 910a, and the second direction may be the width direction of the protrusion 910a.

Specific embodiments of providing light reception components or light emission components on the base 900a will be further explained in subsequent descriptions.

FIG. 5C is a structural diagram of a circuit board provided according to some embodiments of this disclosure. As shown in FIG. 5C, the circuit board 300 includes a base mounting portion 301, in which the base 900a is embedded, thereby securing the base 900a to the surface of the circuit board 300.

In some embodiments, the circuit board 300 is designed for compatibility with different types of light emission passive devices to match them. If the light emission passive device is an optical multiplexing component, multiple beams of optical signals emitted by the laser group are combined into a single beam of optical signal through the optical multiplexing component. The single beam of optical signal is converged via a lens and then transmitted to a fiber collimator. The fiber collimator is connected with a fiber pigtail, through which the optical signal is transmitted out. Since the fiber pigtail has a rigidity, the fiber pigtail exits horizontally along a port of the fiber collimator, and the exiting position is relatively close to the surface of the circuit board, the fiber pigtail may come near to the circuit board under the gravity of the fiber pigtail and even come into contact with the circuit board, causing interference between the fiber pigtail and the circuit board. To avoid the interference between the fiber pigtail and the circuit board, the fiber pigtail may be raised to a height such that a space is formed between the fiber pigtail and the circuit board, thereby avoiding their interference from each other. When trying to raise the fiber pigtail, the fiber pigtail may get broken due to interference between the fiber pigtail and the surface of the circuit board and no space is left for bending of the fiber pigtail. Accordingly, when there are two optical multiplexing components, a first notch portion 302 and a second notch portion 303a are respectively formed at an end face of the base mounting portion 301. For example, the first notch portion 302 and the second notch portion 303a are located at an end of the base mounting portion 301 away from the light reception chip. As such, the provision of the first notch portion 302 and the second notch portion 303a provides spaces for bending of the fiber pigtails when trying to raise the fiber pigtails, such that, when the fiber pigtail are raised, portions of the fiber pigtails that interfere with the surface of the circuit board may be bent downwards into the first notch portion 302 and the second notch portion 303a, thereby avoiding the fiber pigtails from being broken. It can be understood that in a case that the light emission passive component is an optical fiber array, the fiber exiting position is far from the surface of the circuit board, and thus there is enough route for the bending of the fiber pigtail before it reaching the surface of the circuit board. In this case, it is unnecessary to form two notch portions at the end face of the base mounting part 301. In this disclosure, with the first notch portion 302 and the second notch portion 303a being formed at the end face of the base mounting portion 301, respectively, the circuit board 300 is enabled to be compatible with different types of light emission passive devices.

FIG. 5D is a schematic assembly diagram of the first base and the circuit board provided according to some embodiments of this disclosure. As shown in FIG. 5D, the circuit board 300 is formed with the base mounting portion 301 in its surface, and the first supporting portions 924a are formed at opposite sides of the base 900a, respectively. In some embodiments, the first supporting portions 924a disposed at the opposite sides of the base 900a are embedded in the base mounting portion 301, and then surfaces of the first supporting portions 924a facing outward respectively abutting on surfaces of the circuit board 300, thereby securing the base 900a to the surface of the circuit board 300 and achieving a fixed connection between the base 900a and the circuit board 300.

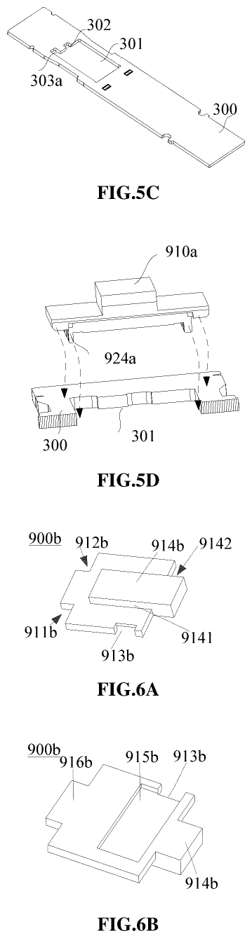

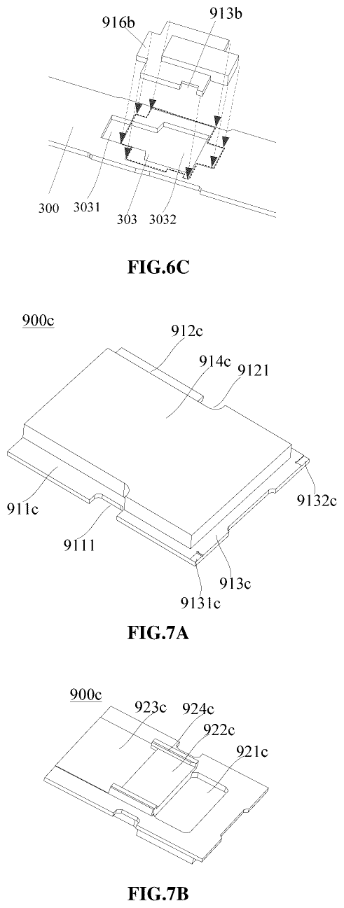

FIG. 6A is a first structural diagram of a second base provided according to some embodiments of this disclosure, and FIG. 6B is a second structural diagram of the second base provided according to some embodiments of this disclosure. As shown in FIG. 6A and FIG. 6B, in some embodiments, the light reception component and the light emission component are arranged on different surfaces of the same base, where the base may be a base 900b.

FIG. 6A shows a structure of one surface of the base 900b. As mentioned above, the light reception component and the light emission component are disposed on different surfaces of the base 900b, respectively. For example, an upper surface of the base 900b is configured to carry the light reception component, and a lower surface of the base 900b is configured to carry the light emission component. Wherein, the surface shown in FIG. 6A is the upper surface of the base 900b, and thus a surface opposite to the upper surface is the lower surface of the base 900b.

A protrusion 914b is formed on the upper surface of the base 900b which is protruded relative to the upper surface. The function of the protrusion 914b is the same as that of the above-mentioned protrusion 910a, namely to help to dissipate heat through contact with the upper shell part. Similarly, light reception passive devices are provided on both sides of the protrusion 910a to achieve a multi-path reception. The light reception passive device may be an optical fiber array, an optical demultiplexing component, an AWG, or the like. In some embodiments, the light reception passive device also includes a fiber collimator or the like.

An upper surface of the protrusion 914b is protruded upwards relative to the upper surface of the base 900b, and one end of the protrusion 914b is protruded relative to a sidewall of the base 900b. A first light reception passive device is located at a first sidewall 9141 of the protrusion 914b, and a second light reception passive device is located at a second sidewall 9142 of the protrusion 914b. The second sidewall 9142 is located opposite to the first sidewall 9141.

The base 900b is formed with a first notch 911b, and an edge of the first notch 911b functions to limit the light reception passive device in a length direction. The function of the first notch 911b will be explained in the following descriptions.

The base 900b is formed with a second notch 912b, and an edge of the second notch 912b functions to limit the light reception passive device in a length direction. The function of the second notch 912b will be explained in the following descriptions.

The base 900b is also formed with a third notch 913b, and the provision of the third notch 913b facilitates to positioning and observing the base 900b and the circuit board 300 during installation.

FIG. 6B shows a structure of the other surface of the base 900b. As shown in FIG. 6B, the lower surface of the base 900b is recessed to form a first recess 915b, and the lower surface of the base 900b contacts and connects with the upper surface of the circuit board. A bottom surface of the first recess 915b is recessed relative to the lower surface of the base 900b so as to minimize electrical connection lines between the light emission component and the circuit board.

In some embodiments, the first recess 915b is communicated with the third notch 913b, thereby facilitating observation of positioning via the third notch 913b during installation.

FIG. 6C is a schematic assembly diagram of the second base and the circuit board provided according to some embodiments of this disclosure. As shown in FIG. 6C, in some embodiments of this disclosure, the base mounting portion 303 is formed as a hollow-out structure of the circuit board 300, and the base mounting portion 303 includes a first mounting portion 3031 and a second mounting portion 3032, with a width of the second mounting portion 3032 being larger than that of the first mounting portion 3031. The first mounting portion 3031 is adjacent to an optical port, and the second mounting portion 3032 is adjacent to an electrical port. A DSP chip is provided on the upper surface of the circuit board 300, the light reception component is located on the upper surface of the base 900b, and the light emission component is located on the lower surface of the base 900b.

A width of the base 900b is larger than a width of the second mounting portion 3032. The base 900b is located on the upper surface of the circuit board 300, and the base 900b covers the second mounting portion 3032. The base 900b does not fully cover the first mounting portion 3031 such that a part of the first mounting portion 3031 is left as a gap between the circuit board and the base 900b, which facilitates to clamp and mount an optical fiber splice.

In order to shorten connection lines between the light emission component and the circuit board, pins of the light emission component are flush with the lower surface of the circuit board. In order to achieve avoidance installation of the light emission component, the first recess 915b is located at the second mounting portion 3032.

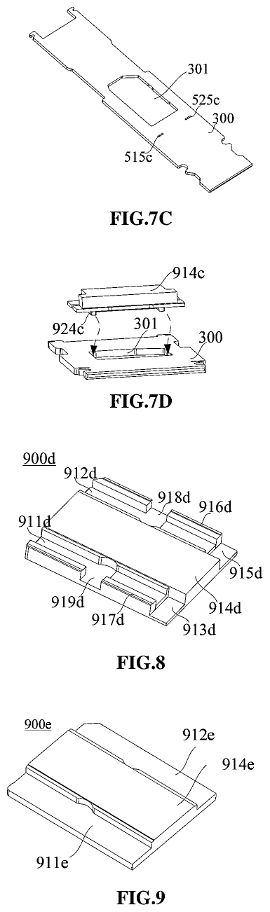

FIG. 7A is a first structural diagram of a third base provided according to some embodiments of this disclosure, and FIG. 7B is a second structural diagram of the third base provided according to some embodiments of this disclosure. As shown in FIG. 7A and FIG. 7B, the base may be a base 900c.

FIG. 7A shows a structure of one surface of the base 900c. As mentioned above, the light reception component and the light emission component may be disposed on different surfaces of the base 900c, respectively. For example, the upper surface of the base 900c is configured to carry the light reception component, and the lower surface thereof is configured to carry the light emission component. Wherein, the surface shown in FIG. 7A is the upper surface of the base 900c, and the opposite surface is the lower surface of the base 900c.

Similarly, the surface of the base 900c is protruded upwards to form a protrusion 914c. Heat dissipation of the light emission component can be achieved through contact of the protrusion 914c with the upper shell part. The surface of the base 900c further includes a first carrying surface 911c, a second carrying surface 912c, and a third carrying surface 913c located at different sides of the protrusion 914c. For example, the first carrying surface 911c and the second carrying surface 912c are located at two sides in a length direction of the protrusion 914c, respectively, and the third carrying surface 913c is located at one side in a width direction of the protrusion 914c. Surfaces of the first carrying surface 911c, the second carrying surface 912c and the third carrying surface 913c are all lower than the surface of the protrusion 914c. The second carrying surface 912c is located opposite to the first carrying surface 911c, and the third carrying surface 913c is located adjacent to the first carrying surface 911c.

In order to achieve reception of multi-path optical signals, a first light reception component is disposed at one side of the protrusion 914c, and a second light reception component is disposed at the other side of the protrusion 914c. A light reception chip of the first light reception component is disposed on the surface of the circuit board, while the other optical elements thereof are disposed on the surface of the base 900c. Similarly, a light reception chip of the second light reception component is disposed on the surface of the circuit board, and the other optical elements thereof are disposed on the surface of the base 900c.

For example, in the case that light reception passive devices of the first and second light reception components are Arrayed Waveguide Gratings (AWGs), the first light reception passive device disposed on the surface of the first carrying surface 911c is a first AWG, and the second light reception passive device disposed on the surface of the second carrying surface 912c is a second AWG.

For example, the first AWG and the second AWG may be placed vertically on the corresponding carrying surfaces, that is, light exiting end faces thereof are vertical to the surface of the circuit board, such that multiple paths of optical signals are arranged vertically, that is, a plane formed by paths of the multi-path optical signals is perpendicular to the surface of the circuit board. For example, the first AWG and the second AWG may be placed horizontally on the corresponding carrying surfaces, that is, light exiting end faces thereof are placed horizontal to the surface of the circuit board, such that the multi-path optical signals are arranged in parallel, that is, a plane formed by paths of the multi-path optical signals is parallel to the surface of the circuit board. For example, the light exiting ends of the first AWG and the second AWG have reflective surfaces. Alternatively, the light exiting ends of the first AWG and the second AWG have no reflective surfaces.

For example, the first AWG and the second AWG may be placed vertically on the corresponding carrying surface, and the light exiting ends of the first AWG and the second AWG have no reflective surfaces, that is, the light exiting end face of the first AWG is erected on the surface of the first carrying surface 911c, and the light exiting end of the first AWG has no reflective surface; the light exiting end face of the second AWG is erected on the surface of the second carrying surface 912c, and the light exiting end of the second AWG has no reflective surface. The light exiting direction of the first AWG and that of the second AWG are horizontal, that is, parallel to the surface of the circuit board. However, light reception direction of the light reception chip located on the surface of the circuit board is perpendicular to the surface of the circuit board. Therefore, it is necessary to turn optical paths of the optical signals output from the first AWG and the second AWG via optical path turning devices (e.g., turning prisms) to thereby change the transmission directions of the optical paths, for example, to change the transmission direction of the optical signals from a direction parallel to the surface of the circuit board to a direction perpendicular to the surface of the circuit board. Based on this, a first reflective surface and a first optical path turning device may be respectively disposed on a side of the third carrying surface 913C adjacent to the first AWG, such that the optical signal output from the first AWG is transmitted to the first reflective surface, and transmission direction of optical path of the optical signal, after output from the first reflective surface, is changed relative to transmission direction of optical path of the optical signal output from the first AWG. For example, transmission direction of optical path of the optical signal output from the first reflective surface is perpendicular to transmission direction of optical path of the optical signal output from the first AWG. The light is reflected, by the first reflective surface, to the first optical path turning device, and then is turned downwards, through the first optical path turning device, to the surface of the light reception chip array. Similarly, a second reflective surface and a second turning prism may be disposed on a side of the third carrying surface adjacent to the second AWG, respectively, and in this case, the optical signal is output from the second AWG and is transmitted to the second reflective surface. The transmission direction of light exiting optical path from the second reflective surface has changed relative to the transmission direction of light exiting optical path from the second AWG. For example, the transmission direction of light exiting optical path from the second reflective surface is perpendicular to the transmission direction of light exiting optical path from the second AWG. The light is reflected, by the second reflective surface, to the second optical path turning device, and then is turned downwards, through the second optical path turning device, to the surface of the light reception chip array. For example, the first reflective surface and the second reflective surface may be a first reflective mirror and a second reflective mirror, respectively.

For example, in the case that the first AWG and the second AWG may be placed vertically on the corresponding carrying surfaces and the light exiting ends of the first AWG and the second AWG each has a reflective surface, the light exiting end face of the first AWG is erected on the surface of the first carrying surface 911c, and the light exiting end of the first AWG has a reflective surface; and the light exiting end face of the second AWG is erected on the surface of the second carrying surface 912c, and the light exiting end of the second AWG has a reflective surface. The light exiting ends of the first and second AWGs have tilted reflective surfaces, which may replace the above-mentioned first and second reflective surfaces. Therefore, optical path turning devices (e.g., first and second turning prisms) may be disposed in light exiting directions of the first and second AWGs, respectively, and the optical signals output by the first and second AWGs are turned, through the first and second turning prisms, towards the surface of the light reception chip. In this disclosure, each AWG is vertically disposed on the corresponding carrying surface, which can reduce the area occupied by the AWG and thus reduce the size of the base.

For example, in the case that the first and second AWGs may be placed horizontally on the corresponding carrying surfaces and the light exiting end faces of the first and second AWGs are both horizontal end face, optical path turning devices (e.g., first and second turning prisms) are respectively disposed in the light exiting directions of the first and second AWGs. The transmission directions of the optical signals are changed through the first and second turning prisms, such that the optical signals output by the first and second AWGs are turned towards the surface of the light reception chip.

In some embodiments, the AWG includes an AWG chip and a capillary that are connected via a connecting component. For example, the connecting component may be adhesive. In order to make way for the adhesive, a first avoidance portion 9111 is formed in the surface of the first carrying surface 911c, and a second avoidance portion 9121 is formed in the surface of the second carrying surface 912c. In some embodiments, in order to limit optical devices disposed on the third carrying surface 913c, the third carrying surface 913c is formed with a first limiting groove 9131c on the side thereof adjacent to the first AWG and a second limiting groove 9132c on the side thereof adjacent to the second AWG.

FIG. 7B shows a structure of the other surface of the base 900c. As shown in FIG. 7B, the other surface of the base 900c is the lower surface of the base 900c, which is configured to mount the light emission component. The lower surface of the base 900c is formed with a fourth carrying surface 921c, a fifth carrying surface 922c, and a sixth carrying surface 923c, respectively. The fifth carrying surface 922c is located between the fourth carrying surface 921c and the sixth carrying surface 923c.

In some embodiments, the fourth carrying surface 921c is configured to dispose a laser group for emitting multiple paths of optical signals; the fifth carrying surface 922c is configured to dispose an optical multiplexing component for combining the multiple paths of optical signals; and the sixth carrying surface 923c is configured to dispose a fiber collimator for transmitting the combined optical signal.

In order to limit and secure the optical multiplexing component, the fifth carrying surface 922c is formed with limiting portions 924c at its opposite sides. For example, the surface of the limiting portion 924c protrudes relative to the surface of the fifth carrying surface 922c, and the limiting portion 924c may be configured as a limiting boss, thereby limiting and securing the optical multiplexing component.

FIG. 7C is a structural diagram of another circuit board provided according to some embodiments of this disclosure. As shown in FIG. 7C, a light reception chip 515c and a light reception chip 525c are disposed on the surface of circuit board 300, respectively. The light reception directions of the two light reception chips are perpendicular to the surface of the circuit board. Therefore, it is possible to use optical path turning devices (e.g., the above-mentioned first and second turning prisms) to turn the optical paths of the optical signals so as to transmit the optical signals into the light reception chips.

In order to secure the base 900c to the surface of the circuit board 300, the circuit board 300 is formed, in its surface, with a base mounting portion 301. For example, the base mounting portion 301 may be a through-hole structure. The base 900c is embedded into the base mounting portion 301 to secure the base 900c to the circuit board 300.

FIG. 7D shows an assembly diagram of a third base and a circuit board provided according to some embodiments of this disclosure. As shown in FIG. 7D, in some embodiments, the circuit board 300 is formed, in its surface, with a base mounting portion 301. For example, the base mounting portion 301 may be a through-hole structure. The limiting portion 924c of the base 900c is embedded in the base mounting portion 301, and a surface of the limiting portion 924c facing outwards is mounted to the surface of the circuit board 300, thereby securing the base 900c to the circuit board 300.

FIG. 8 is a structural diagram of a fourth base provided according to some embodiments of this disclosure. As shown in FIG. 8, in some embodiments, the light reception component and the light emission component are arranged on different surfaces of the same base, where the base may be a base 900d. FIG. 8 shows a structure of an upper surface of the base 900d, and a structure of a lower surface of the base 900d may refer to the lower surface structure of base 900c as mentioned above. Similar to the aforementioned bases, the upper surface of the base 900d protrudes upwards to form a protrusion 914d. The protrusion 914d may contact with the upper shell part to achieve heat dissipation of the light emission component.

A first carrying surface 911d and a second carrying surface 913d are respectively formed on one side of the protrusion 914d, with the surface of the second carrying surface 913d being lower than that of the first carrying surface 911d to match the optical path between the optical devices; and a third carrying surface 912d and a fourth carrying surface 915d are formed on the other side of the protrusion 914d, with the surface of the fourth carrying surface 915d being lower than that of the third carrying surface 912d to match the optical path between the optical devices.

In some embodiments, the AWGs may be placed horizontally on the corresponding carrying surfaces. For example, the first AWG is placed horizontally on the first carrying surface 911d, and the second AWG is placed horizontally on the third carrying surface 912d. The first AWG is disposed on the surface of the first carrying surface 911d, and the light exiting end face of the first AWG is arranged horizontally to the surface of the first carrying surface 911d, with the light exiting end face of the first AWG being a planar surface. The second AWG is disposed on the surface of the third carrying surface 912d, and the light exiting end face of the second AWG is placed horizontally to the surface of the third carrying surface 912d, with the light exiting end face of the second AWG being a planar surface.

Similarly, it is necessary to provide optical path turning devices (e.g. turning prisms) to turn optical paths of optical signals output by the AWGs so as to transmit the optical signals to the surface of the light reception chip. Based on this, a first optical path turning device (e.g., a first turning prism) is disposed on the surface of the second carrying surface 913d to turn the optical path of the optical signal output by the first AWG; a second optical path turning device (e.g., a second turning prism) is disposed on the surface of the fourth carrying surface 915d to turn the optical path of the optical signal output by the second AWG. In order to match the height of the optical path, the surface of the second carrying surface 913d is lower than the surface of the first carrying surface 911d, and the surface of the fourth carrying surface 915d is lower than the surface of the third carrying surface 912d.

In order to transmit the optical signal output by the AWG to the surface of the light reception chip, a portion of the surface of the first turning prism is mounted on the surface of the circuit board 300, while another portion thereof is suspended to allow the optical signal to be transmitted through the first turning prism to the surface of the light reception chip. The second turning prism is also provided in this way.

In order to facilitate to limiting the corresponding turning prisms, an end face of the protrusion 914d is flush with an end face of the second carrying surface 913d and an end face of the fourth carrying surface 915d, respectively.

In order to make way for (or to get out of the way of) connecting components between the AWG chips and capillaries in the AWGs, a first limiting portion 919d is formed in the surface of the first carrying surface 911d, and a second limiting portion 918d is formed in the surface of the third carrying surface 912d, to thereby avoid or make way for the connecting components, respectively. For example, the connecting component may be adhesive.

In some embodiments, in order to limit and secure the AWGs, a fencing portion 917d is formed on a side of the first carrying surface 911d, and a fencing portion 916d is formed on a side of the third carrying surface 912d to respectively provide a fence having a height for the first and second AWGs, thereby achieving the limiting and securing of the AWGs.

FIG. 9 is a structural diagram of a fifth base provided according to some embodiments of this disclosure. As shown in FIG. 9, in some embodiments, the light reception component and the light emission component are arranged on different surfaces of the same base, where the base may be the base 900e. FIG. 9 shows a structure of an upper surface of the base 900e, and a structure of a lower surface of the base 900e may refer to that of the lower surface structure of the base 900c as mentioned above. Similar to the aforementioned bases, the upper surface of the base 900e protrudes upwards to form a protrusion 914e. The protrusion 914d may contact with the upper shell part so as to achieve heat dissipation of the light emission component.

A first carrying surface 911e is formed on one side of the protrusion 914e and a second carrying surface 912e is formed on the other side of the protrusion 914e. For example, in order to facilitate limiting optical devices, end faces of the first carrying surface 911e and the second carrying surface 912e may be flush with end faces of the protrusion 914e. The surface of the protrusion 914e is protruded relative to the first carrying surface 911e and the second carrying surface 912e.

In order to achieve reception of multi-path optical signals, a first light reception component is provided on the surface of the first carrying surface 911e, and a second light reception component is provided on the surface of the second carrying surface 912e. In some embodiments, the first light reception component may include a first fiber collimator, a first optical demultiplexing component, and a first turning prism; and the second light reception component may include a second fiber collimator, a second optical demultiplexing component, and a second turning prism.

The first fiber collimator, the first optical demultiplexing component and the first turning prism are provided on the surface of the first carrying surface 911e. The second fiber collimator, the second optical demultiplexing component, and the second turning prism are provided on the surface of the second carrying surface 912e.

The first turning prism is disposed on the side of the first carrying surface 911e adjacent to the light reception chip so as to turn the optical path of the multiple paths of optical signals output by the first optical demultiplexing component to the surface of the light reception chip, and transmit the optical signals to the surface of the light reception chip. The second turning prism is disposed on the side of the second carrying surface 912e adjacent to the light reception chip so as to turn the optical path of the multiple paths of optical signals output by the second optical demultiplexing component to the surface of the light reception chip, and transmit the optical signals to the surface of the light reception chip.

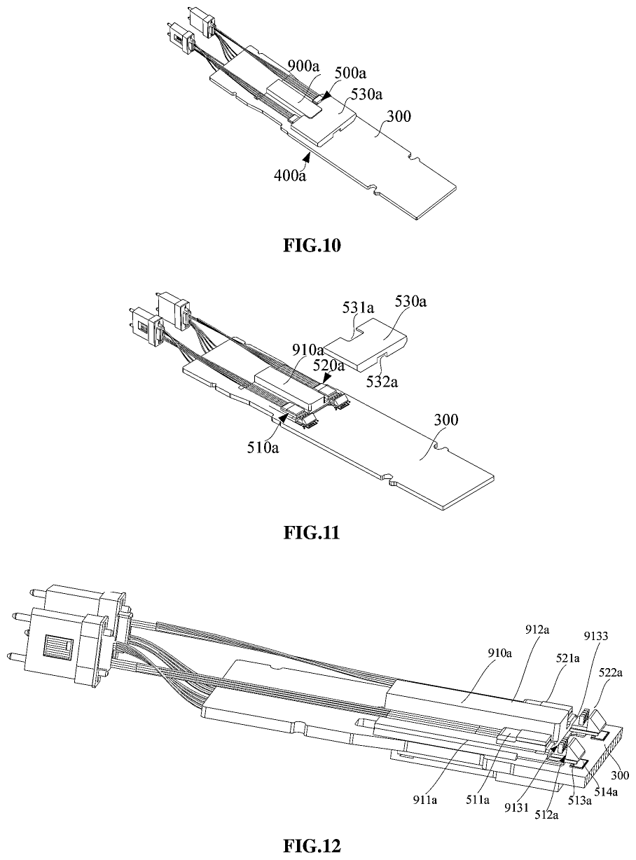

FIG. 10 is an assembly structural diagram of a light reception component provided according to some embodiments of this disclosure, and FIG. 11 is an exploded assembly diagram of a light reception component provided according to some embodiments of this disclosure. As shown in FIG. 10 and FIG. 11, in some embodiments, taking the base being base 900a as an example, the base 900a is embedded in the surface of the circuit board 300. The different surfaces of the base 900a are configured to dispose the light reception component and the light emission component. For example, the upper surface of the base 900a is configured to dispose the light reception component 500a, and the lower surface thereof is configured to dispose the light emission component 400a. Wherein, the term “upper surface” refers to the surface shown in FIG. 10, and the “lower surface” refers to the surface opposite to the upper surface. In this disclosure, the light reception component 500a may also be disposed on the lower surface of the base 900a, while the light emission component 400a may also be disposed on the upper surface of the base 900a.

A first protective cover 530a may be covered over the surface of the base 900a so as to protect optical elements of the light reception component 500a that are disposed on the surface of the base 900a. For example, in the case that some optical elements of the light reception component are disposed on the upper surface of the base 900a, the upper surface of the base 900a may be covered with the first protective cover 530a.

Part of the surface of the base 900a is protruded upwards to form a protrusion 910a. In order to achieve a reception of multi-path optical signals, a first light reception component 510a is provided at one side of the protrusion 910a, and a second light reception component 520a is provided at the other side of the protrusion 910a.

In some embodiments, the first protective cover 530a has a first notch 531a and a second notch 532a. The first notch 531a is configured to avoid (that is, to make way for) the protrusion 910a, and the second notch 532a is configured to avoid electrical elements on the surface of circuit board 300, such as capacitors, resistors, etc. For example, the first notch 531a faces the protrusion 910a and is contiguous to one end of the protrusion 910a so as to avoid the protrusion 910a; and the second notch 532a faces towards the circuit board to avoid the electrical elements on the surface of circuit board 300.

FIG. 12 is a sectional structural diagram of a light reception component provided according to some embodiments of this disclosure. As shown in FIG. 12, and as mentioned above, in order to achieve a reception of multi-path optical signals, a first light reception passive device is disposed on the first carrying surface 911a at one side of the protrusion 910a, and a second light reception passive device is disposed on the second carrying surface 912a at the other side of the protrusion 910a. A first extension portion 9131 is formed at an end of the first carrying surface 911a, and a second extension portion 9133 is formed at an end of the second carrying surface 912a.

In some embodiments, the first light reception passive device of the first light reception component 510a may be an optical fiber array or the other form of light reception passive device. The optical fiber array of the first light reception component 510a is described as a first optical fiber array 511a, and the optical fiber array of the second light reception component 520a is described as a second optical fiber array 521a.

The first light reception component 510a also includes a first turning prism so as to adjust a transmission direction of an optical signal from a direction parallel to the surface of the circuit board to a direction perpendicular to the surface of the circuit board such that it may be received by the first optical fiber array. Similarly, the second light reception component 520a also includes a second turning prism to adjust a transmission direction of an optical signal from a direction parallel to the surface of the circuit board to a direction perpendicular to the surface of the circuit board such that it may be received by the second light reception array. A lens (e.g., a converging lens) is provided in a light entering direction of the first or second turning prism to improve optical coupling efficiency. In the case that the structural unit containing the lens and the first or second turning prism is described as a lens component, a first lens component 512a may be provided at a position along a light exiting direction of the first optical fiber array, and a second lens component 522a may be provided at a position along a light exiting direction of the second optical fiber array.

The first optical fiber array 511a is disposed on the surface of the first carrying surface 911a, and the first lens component 512a is disposed on the surface of the first extension portion 9131. The second optical fiber array 521a is disposed on the surface of the second carrying surface 912a, and the second lens assembly 522a is disposed on the surface of the second extension portion 9133.

In some embodiments, the first light reception component 510a further includes a light reception chipset and a transimpedance amplifier that are disposed on the surface of the circuit board. For example, the light reception chipset includes several light reception chips 513a, which are configured to convert optical signals into electrical signals; and the light reception chips 513a are electrically connected to the transimpedance amplifier 514a to amplify the electrical signals through the transimpedance amplifier. For example, the light reception chips 513a and the transimpedance amplifier 514a may be connected by wire bonding to achieve the electrical connection between them. The surface of the light reception chip 513a has a first connecting pad and also has a photosensitive surface. Typically, the first connecting pad and the photosensitive surface of the light reception chip are on the same surface. The surface of the transimpedance amplifier has a second connecting pad, and a wire bonding connection is made between the first connecting pad and the second connecting pad to achieve the electrical connection between them. In this case, the photosensitive surface and the first connecting pad of the light reception chip 513a are facing upwards, and thus the photosensitive surface is exposed to the air. In this regard, in order to reduce reflection of optical signals into the air and allow more optical signals to be absorbed into the photosensitive surface, the surface of the photosensitive surface can be coated with an antireflective film which has a refractive index larger than that of the air, such that more optical signals are transmitted into the photosensitive surface, thereby ensuring the light reception power.

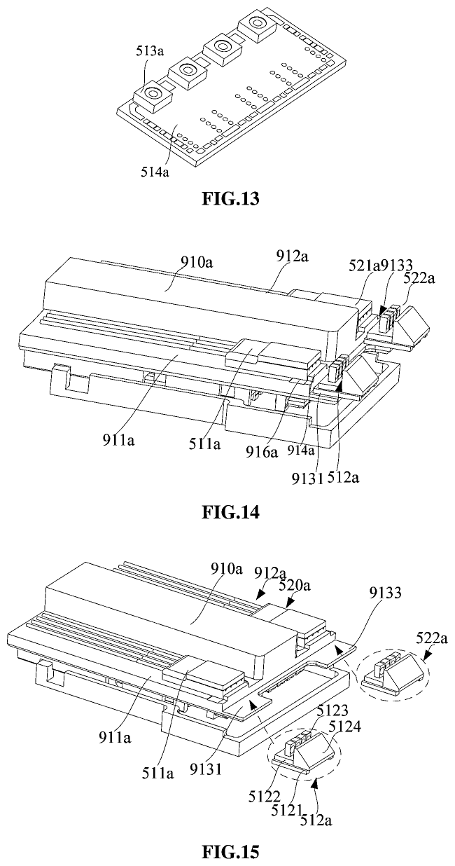

FIG. 13 is a schematic diagram showing an electrical connection between a light reception chip and a transimpedance amplifier provided according to some embodiments of this disclosure. FIG. 13 shows another way of electrical connection between the light reception chip and the transimpedance amplifier. As shown in FIG. 13, in some embodiments, the transimpedance amplifier 514a is disposed on the surface of the circuit board 300, and the first connection pad on the surface of the light reception chip 513a and the second connection pad on the surface of the transimpedance amplifier 514a are soldered together, thereby achieving the electrical connection between the light reception chip 513a and the transimpedance amplifier 514a. That is, the light reception chip 513a is mounted up-side-down on the surface of the transimpedance amplifier 514a, with the photosensitive surface of the light reception chip 513a facing downwards. In order to transmit the optical signal to the photosensitive surface, a lens is provided on the surface of the light reception chip 513a that is exposed to air, and a light hole may be formed from the lens to the photosensitive surface, through which the optical signal is transmitted to the photosensitive surface, thereby achieving reception of optical signal. With the light reception chip 513a being mounted and soldered up-side-down onto the transimpedance amplifier 514a, parasitic effects caused by the wire bonding connection can be avoided, thereby improving signal transmission performance. Meanwhile, since the photosensitive surface of the light reception chip 513a is not exposed to air, the reflection of optical signals into the air is reduced, thereby ensuring the light reception power.

In some embodiments, a surface of the transimpedance amplifier 514a is provided with a second connecting pad, and the light reception chip 513a is arranged such that the photosensitive surface thereof is faced upwards, and then is glued to a surface of the second connecting pad. Then, the first connecting pad and the second connecting pad are electrically connected through a via hole, thereby achieving the electrical connection between the light reception chip 513a and the transimpedance amplifier 514a.

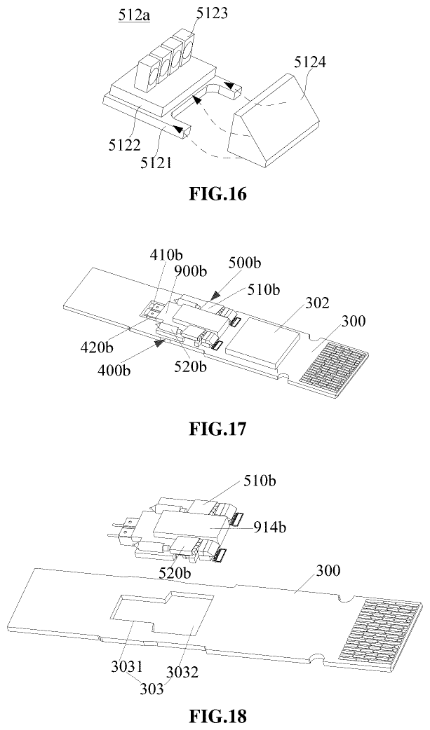

FIG. 14 is a structural diagram of a light reception component provided according to some embodiments of this disclosure, FIG. 15 is an exploded diagram of a light reception component provided according to some embodiments of this disclosure, and FIG. 16 is a structural diagram of a lens component provided according to some embodiments of this disclosure. As shown in FIGS. 14-16, a surface in the middle of the base 900a protrudes upwards to form a protrusion 910a, and surfaces at both sides thereof respectively form a first carrying surface 911a and a second carrying surface 912a. One end of the first carrying surface 911a extends to form a first extension portion 9131, and one end of the second carrying surface 912a extends to form a second extension portion 9133. The first light reception component is disposed at one side of the protrusion 910a, and the second light reception component is disposed at the other side of the protrusion 910a, to thereby achieve a reception of multi-path optical signals.

The first carrying surface 911a and the first extension portion 9131 are respectively used to carry the first optical fiber array 511a and the first lens component 512a. The first lens component 512a is configured to turn the optical signal received by the first optical fiber array 511a towards the surface of the circuit board 300, thereby transmitting the optical signal to the surface of the light reception chip. The second carrying surface 912a and the second extension 9133 are respectively used to carry the second optical fiber array 521a and the second lens component 522a. The second lens component 522a is configured to turn the optical signal received by the second optical fiber array 521a towards the surface of the circuit board 300, thereby transmitting the optical signal to the surface of the light reception chip.

In some embodiments, in order to limit the first optical fiber array 511a and the second optical fiber array 521a, respectively, a first limiting tab 914a is formed between the first extension 9131 and the first carrying surface 911a, and a second limiting tab 915a is formed between the second extension 9133 and the second carrying surface 912a. The surface of the first limiting tab 914a is higher than the surface of the first carrying surface 911a to limit the first optical fiber array 511a in a first direction. The surface of the second limiting tab 915a is higher than the surface of the second carrying surface 912a to limit the second optical fiber array 521a in the first direction. For example, the first direction may be in a length direction of the protrusion 910a. Each of the two limiting tabs has the same width as that of the corresponding optical fiber array to limit the first optical fiber array 511a and the second optical fiber array 521a in a second direction. For example, the second direction may be in a width direction of the protrusion 910a.

In some embodiments, since the surface of the first limiting tab 914a is higher than the surface of the first carrying surface 911a, and the surface of the second limiting tab 915a is higher than the surface of the second carrying surface 912a, a chamfer will be formed at a junction of the limiting tab and its corresponding carrying surface during the processing of the base. When mounting the light reception passive device, the presence of the chamfer would cause the end of the light reception passive device to be raised at the chamfer, resulting in uneven mounting of the light reception passive device and thus reducing the stability of the reception optical path. Therefore, a first depression 916a is formed at the junction of the first limiting tab 914a and the first carrying surface 911a, and a second depression 917a is formed at the junction of the second limiting tab 915a and the second carrying surface 912a. The provision of the first depression 916a enables an end face of the first light reception passive device to horizontally abut against a wall surface of the first limiting tab 914a, thereby ensuring a smooth mounting of the first light reception passive device. Similarly, the second depression 917a is provided so as to enable that an end face of the second light reception passive device to horizontally abut against a wall surface of the second limiting tab 915a, thereby ensuring a smooth mounting of the second light reception passive device. For example, the surface of the first depression 916a gradually tilts towards the wall surface of the first limiting tab 914a, and the surface of the second depression part 917a gradually tilts towards the wall surface of the second limiting tab 915a, such that the surfaces of the ends of the first depression 916a and the second depression 917a adjacent to the corresponding limiting tabs are concave, to avoid interference with the light reception passive devices and ensure the smooth mounting of the light reception passive devices, thereby ensuring the stability of the reception optical path.

As shown in FIG. 15, the first lens component 512a is disposed on the surface of the first extension portion 9131, and the second lens component 522a is disposed on the surface of the second extension portion 9133. In order to ensure that optical path of the first lens component 512a and that of the first optical fiber array 511a are at the same height, the surface of the first extension portion 9131 is lower than the surface of the first carrying surface 911a, and similarly, the surface of the second extension portion 9133 is lower than the surface of the second carrying surface 912a.

In this disclosure, in order to facilitate the mounting of the light reception chip array on the surface of the circuit board 300, extension lengths of the first extension portion 9131 and the second extension portion 9133 are provided to allow the light reception chip array to be exposed. The first optical path turning device is disposed on the surface of the first extension portion 9131 via a first substrate, and an extension length of the first substrate is longer than an extension length of the first extension portion 9131 such that the first optical path turning device is located above the surface of the light reception chip array. Similarly, the second optical path turning device is disposed on the surface of the second extension portion 9133 via a second substrate; and an extension length of the second substrate is longer than an extension length of the second extension portion such that the second optical path turning device is located above the surface of the light reception chip array.

As shown in FIG. 15 and FIG. 16, the first lens component 512a includes a substrate 5121, an underplate 5122, a converging lens 5123 and a turning prism 5124. Similarly, the second lens component 522a also includes similar optical elements as mentioned above. The substrate 5121 is the above-mentioned first substrate.

In this disclosure, light reception chips and TIAs are mounted on the surface of the circuit board 300 below the first extension portion 9131 and the second extension portion 9133. In order to facilitate to mount the light reception chips and TIAs, extension lengths of the first extension portion 9131 and the second extension portion 9133 cannot be too long to make it difficult to mount the light reception chips and TIAs. For example, the extension lengths of the first extension portion 9131 and the second extension portion 9133 are provided to allow the light reception chips and TIAs to be exposed, which thus facilitates mounting of the light reception chips and TIAs.

One end of the substrate 5121 is configured to carry the underplate 5122, and the underplate 5122 is configured to carry the converging lens 5123. The other end of the substrate 5121 is configured to carry the turning prism 5124. Meanwhile, the length of the substrate 5121 is longer than any of the lengths of the first extension portion 9131 and the second extension portion, such that the turning prism 5124 is located above the light reception chip and TIA.

In order to allow light output by the turning prism 5124 to be transmitted to the surface of the light reception chip, the carrying surface of the substrate 5121 for carrying the turning prism 5124 is provided with a light hole, such that the light output by the turning prism 5124 can pass through the light hole and reach the surface of the light reception chip. For example, the carrying surface of the substrate 5121 for carrying the turning prism 5124 is formed in a U-shape. Arms formed on both sides of the U-shaped carrying surface are used to support the turning prism 5124. An opening formed in a middle of the U-shaped carrying surface is the light hole. The light output by the turning prism 5124 can pass through the light hole and reach the surface of the light reception chip.

For example, the turning prism 5124 is carried by the substrate 5121 such that the turning prism 5124 is located above the light reception chip and TIA, and the converging lens 5123 is carried by the underplate 5122 such that the optical path of the converging lens 5123 matches with the optical path of the turning prism 5124. The end face of the underplate 5122 facing the turning prism 5124 bears against and is connected to the turning prism 5124, and the end face of the underplate 5122 facing the turning prism 5124 may be used to limit and secure the turning prism 5124.

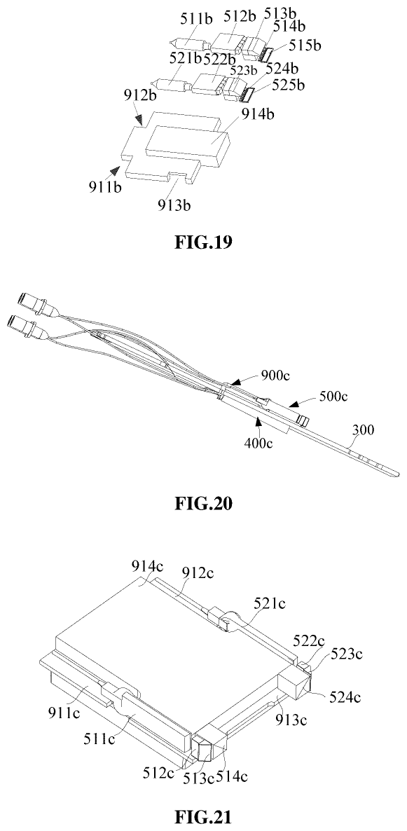

FIG. 17 is a schematic assembly diagram of another light reception component provided according to some embodiments of this disclosure, FIG. 18 is a structural schematic diagram of another light reception component provided according to some embodiments of this disclosure, and FIG. 19 is an exploded schematic diagram of another light reception component provided according to some embodiments of this disclosure. As shown in FIGS. 17-19, in some embodiments, taking the base being the base 900b as an example, the circuit board 300 is provided with a base mounting portion 303, and the base 900b is located above the base mounting portion 303. The light reception component is located above the base 900b, and the light emission component is located below the base 900b.

In order to achieve reception of multi-path optical signals, a first light reception component 510b is provided at one side of the protrusion, and a second light reception component 520b is provided at the other side of the protrusion. The first light reception component 510b and the second light reception component 520b are disposed on the same surface of the base. For example, the first light reception component 510b and the second light reception component 520b are located on the upper surface of the base. For example, the upper surface of the base 900b protrudes upwards to form a protrusion 914b. The first light reception component 510b and the second light reception component 520b are disposed at opposite sides of the protrusion 914b.

In some embodiments, the first light reception component 510b includes a first optical collimator 511b, a first demultiplexer 512b, a first lens component 513b, a first optical chipset 514b and a first transimpedance amplifier 515b. The first optical collimator 511b and the first demultiplexer 512b are located on the upper surface of the base 900b at a first sidewall 9141 of the protrusion 914b. The first lens component 513b, the first optical chipset 514b and the first transimpedance amplifier 515b are located on the upper surface of the circuit board 300.

For the convenience of assembly, the first sidewall 9141 functions to locate the first optical collimator 511b and the first demultiplexer 512b, and the first optical collimator 511b and the first demultiplexer 512b are connected to the upper surface of the base 900b. The first lens component 513b includes a first coupling substrate, a first converging lens group and a first reflective prism. The first coupling substrate is located on the upper surface of the circuit board so as to provide a suitable mounting height for the first converging lens group and the first reflective prism, such that central axes of the first converging lens group and the first reflecting prism have a height consistent with the first optical collimator 511b and the first demultiplexer 512b, thereby achieving the optical path coupling.

The first optical collimator 511b is connected to an optical fiber adapter via an optical fiber, to receive signal light from the outside and collimate the signal light. The first demultiplexer 512b demultiplexes the signal light output from the first optical collimator 511b into signal lights having different wavelengths. The first converging lens group converges the demultiplexed signal lights, the first reflective prism reflects the converged lights to the first optical chipset 514b, and the first optical chipset 514b converts the optical signals into electrical signals and transmits the same to the first transimpedance amplifier 515b.

The second light reception component 520b includes a second optical collimator 521b, a second demultiplexer 522b, a second lens component 523b, a second optical chipset 524b and a second transimpedance amplifier 525b. The second optical collimator 521b and the second demultiplexer 522b are located on the upper surface of the base 900b at a second sidewall 9142 of the protrusion 914b. The second lens component 523b, the second optical chipset 524b, and the second transimpedance amplifier 525b are located on the upper surface of the circuit board 300.

For the convenience of assembly, the second sidewall 9142 functions to locate the second demultiplexer 522b, and the second optical collimator 521b and the second demultiplexer 522b are connected to the upper surface of the base 900b. In order to match central optical axes of the second optical collimator 521b, the second demultiplexer 522b and the second lens component, the second lens component 523b includes a second coupling substrate, a second converging lens component and a second reflective prism. The second coupling substrate is located on the upper surface of the circuit board for providing an installation platform for the second converging lens group and the second reflective prism, such that central axes of the second converging lens group and the second reflective prism have a height consistent with the second optical collimator 521b and the second demultiplexer 522b, thereby achieving the optical path coupling.

The second optical collimator 521b is connected to an optical fiber adapter via an optical fiber, to receive signal light from the outside and collimate the signal light. The second demultiplexer 522b demultiplexes the signal light output from the second optical collimator 521b into signal lights having different wavelengths. The second converging lens group converges the demultiplexed signal lights, the second reflective prism reflects the converged lights to the second optical chipset 524b, and the second optical chipset 524b converts the optical signals into electrical signals and transmits the same to the second transimpedance amplifier 525b. The first converging lens group and the second converging lens group may be disposed on the base or on the circuit board.

The surface of the base 900b may also be covered with a first protective cover to protect the light reception component disposed on the surface of the base 900a. For example, in case that part of optical elements of the light reception component are disposed on the upper surface of the base 900b, the upper surface of the base 900b is covered with the first protective cover to protect the optical elements.

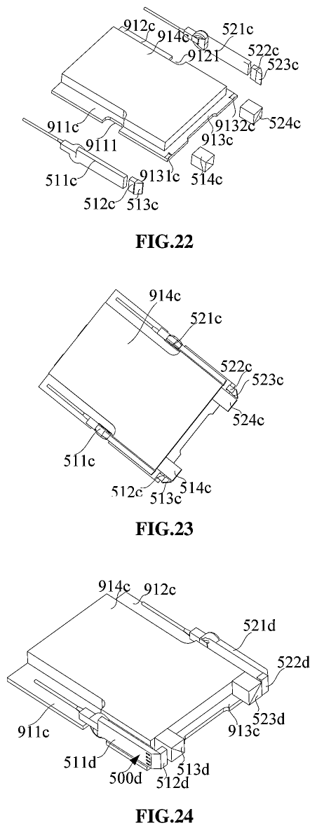

FIG. 20 is a structural assembly diagram of another light reception component provided according to some embodiments of this disclosure, FIG. 21 is a schematic structural diagram of another light reception component provided according to some embodiments of this disclosure, and FIG. 22 is an exploded schematic diagram of another light reception component provided according to some embodiments of this disclosure. As shown in FIGS. 20 to 22, in some embodiments, taking the base being the base 900c as an example, the light reception component 500c and the light emission component 400c are located on different surfaces of the base 900c, respectively. For example, the light reception component 500c is located on the upper surface of the base 900c, and the light emission component 400c is located on the lower surface of the base 900c. The circuit board 300 is provided with a base mounting portion 303, and the base 900c is located above the base mounting portion 303.

In some embodiments, the light reception component 500c and the light emission component 400c are located on different surfaces of the base 900c, respectively. The upper surface of the base 900c protrudes upwards to form a protrusion 914c. The protrusion 914c can contact with the upper shell part to achieve heat dissipation of the light emission component. The upper surface of the base 900c also includes a first carrying surface 911c, a second carrying surface 912c, and a third carrying surface 913c at different sides of the protrusion 914c. For example, the first carrying surface 911c and the second carrying surface 912c are located at two sides of the protrusion 914c in a length direction of the protrusion 914c, respectively, and the third carrying surface 913c is located at one side of the protrusion 914c in a width direction of the protrusion 914c. The surfaces of the first carrying surface 911c, the second carrying surface 912c and the third carrying surface 913c are all lower than the surface of the protrusion 914c.

In order to achieve a reception of multi-path optical signals, a first light reception component is disposed at one side of the protrusion 914c, and a second light reception component is disposed at the other side of the protrusion 914c. For example, in the case that the light reception passive devices of the first and second light reception components are AWGs, a first light reception passive device (e.g., a first AWG) is disposed on the surface of the first carrying surface 911c, and a second light reception passive device (e.g., a second AWG) is disposed on the surface of the second carrying surface 912c. As shown in FIG. 21 and FIG. 22, for example, in the case that the first and second AWGs may be placed vertically on the corresponding carrying surfaces, and light exiting end faces of the first and second AWGs have no reflective surface, the first light reception component is located at one side of the protrusion 914c, and the second light reception component is located at the other side of the protrusion 914c, to achieve the reception of multi-path optical signals.

In some embodiments, the first light reception component includes a first AWG 511c, a first reflective surface 513c, a first turning prism 514c, and a light reception chip disposed on the surface of the circuit board. Among them, the first turning prism 514c is the first optical path turning device. For example, in order to improve optical coupling efficiency, a first lens 512c is further provided between the light exiting end face of the first AWG 511c and the first reflective surface 513c. The optical signals demultiplexed from the first AWG 511c are converged by the first lens 512c, and then are reflected by the first reflective surface 513c into the first turning prism 514c. The first reflective surface 513c reflects the optical signals towards the light entering end face of the first turning prism 514c, and the first turning prism 514c turns the optical path of the received optical signal towards a direction perpendicular to the surface of the circuit board, to transmit each path of optical signal to the light reception chip disposed on the surface of the circuit board 300. The light entering end face and light exiting end face of the first turning prism 514c are located on two adjacent sides, the light entering end face of the first turning prism 514c is provide with the first reflective surface 513c, and the light reception chip is disposed below the light exiting end face. In some embodiments, the second light reception component includes a second AWG 521c, a second reflective surface 523c, a second turning prism 524c, and a light reception chip disposed on the surface of the circuit board. The second turning prism 524c is the second optical path turning device. For example, in order to improve optical coupling efficiency, a second lens 522c is further provided between the light exiting end face of the second AWG 521c and the second reflective surface 523c. The optical path principle of the second light reception component may refer to the optical path principle of the first light reception component.

In this disclosure, the first lens 512c is disposed between the light exiting optical path of the first light reception passive device and the first reflective surface 513c. One end of the first lens 512c is disposed at one end of the third carrying surface, and the other end of the first lens 512c is used to carry the first reflective surface 513c. The second lens 522c is disposed between the light exiting optical path of the second light reception passive device and the second reflective surface 523c. One end of the second lens 522c is disposed at the other end of the third carrying surface, and the other end of the second lens 522c is used to carry the second reflective surface 523c.

One end of the first optical path turning device abuts the sidewall of the protrusion, and the other end of the first optical path turning device is suspended. One end of the second optical path turning device abuts the sidewall of the protrusion, and the other end of the second optical path turning device is suspended. The light entering end of the first turning prism faces the light exiting end face of the first reflective surface, and the light exiting end of the first turning prism faces the light reception chip array. The light entering end of the second turning prism faces the light exiting end face of the second reflective surface, and the light exiting end of the second turning prism faces the light reception chip array.

The first lens 512c, the first reflective surface 513c and the first turning prism 514c are respectively disposed on one side of the third carrying surface 913c; and the second lens 522c, the second reflective surface 523c and the second turning prism 524c are respectively disposed on the other side of the third carrying surface 913c. The first lens 512c and the first reflective surface 513c are fixed by optical adhesive bonding, and similarly, the second lens 522c and the second reflective surface 523c are fixed by optical adhesive bonding.

In some embodiments, the AWG includes an AWG chip and a capillary that are connected through a connecting component. For example, the connecting component may be adhesive. In order to avoid (i.e., to make way for) the adhesive, a first avoidance portion 9111 is formed in the surface of the first carrying surface 911c, and a second avoidance portion 9121 is formed in the surface of the second carrying surface 912c. Since the connecting component has a thickness, in order to further avoid the connecting component, an end of the protrusion 910a adjacent to the third carrying surface 913c has a width larger than a width of the other end of the protrusion 910a, to further avoid the connecting component, and to provide a space sufficient to accommodate fiber pigtails of the first AWG 511c and the second AWG 521c, and thus prevent the fiber pigtails from being bent.

In some embodiments, in order to limit optical elements on the third carrying surface 913c, a first limiting groove 9131c is formed on a side of the third carrying surface 913c adjacent to the first AWG, and a second limiting groove 9132c is formed on a side of the third carrying surface 913c adjacent to the second AWG. For example, the first lens 512c is disposed in the first limiting groove 9131c, and then the first reflective surface 513c is secured to the light exiting end face of the first lens 512c; and the second lens 522c is disposed in the second limiting groove 9132c, and then the second reflective surface 523c is secured to the light exiting end face of the second lens 522c.

FIG. 23 is a top structural diagram of another light reception component provided according to some embodiments of this disclosure. As shown in FIG. 23, the first AWG 511c and the second AWG 521c are respectively disposed at two sides of the protrusion 914c. The first lens 512c is disposed in the first limiting groove 9131c, and then the first reflective surface 513c is secured to the light exiting end face of the first lens 512c. The second lens 522c is disposed in the second limiting groove 9132c, and then the second reflective surface 523c is secured to the light exiting end face of the second lens 522c. The first turning prism 514c and the second turning prism 524c are respectively secured to the end face of the protrusion 914c facing the third carrying surface 913c, and the end face of the protrusion 914c facing the third carrying surface 913c functions to limit and secure the first turning prism 514c and the second turning prism 524c.

In some embodiments, one end of the first turning prism 514c and one end of the second turning prism 524c are disposed on the surface of the third carrying surface 913c, and the other ends thereof are suspended so as to output the optical signals that are turned by the first and second turning prisms.

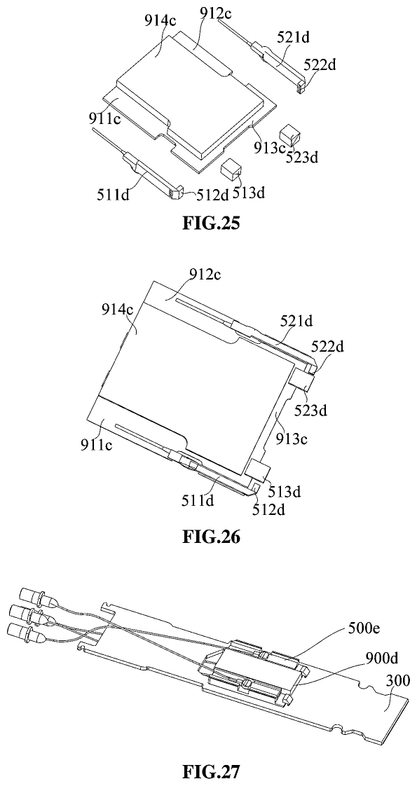

FIG. 24 is a structural schematic diagram of another light reception component provided according to some embodiments of this disclosure, FIG. 25 is an exploded schematic diagram of another light reception component provided according to some embodiments of this disclosure, and FIG. 26 is a top schematic diagram of another light reception component provided according to some embodiments of this disclosure. As shown in FIGS. 24-26, for example, in the case that the first AWG and the second AWG may be placed vertically on the corresponding carrying surfaces and each has a reflective surface at the respective light exiting end, the light reception component is referred to as a light reception component 500d in this case. In order to achieve a reception of multi-path optical signals, the light reception component 500d includes a first light reception component and a second light reception component. The first light reception component includes a first AWG 511d, and the light exiting end face of the first AWG 511d has a reflective surface, through which the optical signal may be reflected towards the light entering end face of the first turning prism 513d. A light reception chip is provided below the light exiting end face of the first turning prism 513d, such that the optical signal reflected by the light exiting end face of the first AWG511d enters the first turning prism 513d, and then the optical signal is turned downwards via the first turning prism 513d, thereby transmitting the optical signal to the surface of the light reception chip. In order to improve optical coupling efficiency, a first converging lens 512d is fixedly connected to the light exiting end face of the first AWG 511d. The second light reception component includes a second AWG 521d, and the light exiting end face of the second AWG 521d also has a reflective surface, through which the optical signal is reflected towards the light entering end face of the second turning prism 523d. A light reception chip is provided below the light exiting end face of the second turning prism 523d, and the second turning prism 523d is configured to turn the optical signal towards the surface of the light reception chip disposed below, thereby transmitting the optical signal to the surface of the light reception chip. Similarly, in order to improve optical coupling efficiency, a second converging lens 522d is fixedly connected to the light exiting end face of the second AWG 521d.

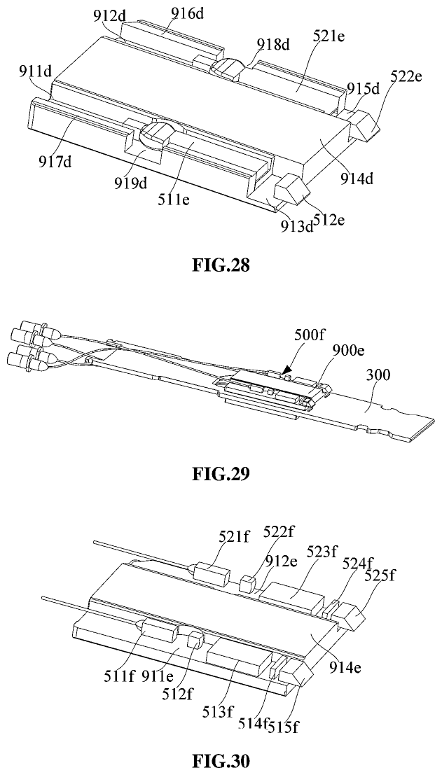

FIG. 27 is a schematic assembly diagram of yet another light reception component provided according to some embodiments of this disclosure, and FIG. 28 is a structural schematic diagram of yet another light reception component provided according to some embodiments of this disclosure. As shown in FIG. 27 and FIG. 28, in some embodiments, taking the base being the base 900d as an example, the light reception component 500e and the light emission component are located on different surfaces of the base 900d, respectively. For example, the light reception component 500e is located on the upper surface of the base 900d, and the light emission component is located on the lower surface of the base 900d. The upper surface of the base 900d protrudes upwards to form a protrusion 914d. The protrusion 914d may contact with the upper shell part to achieve heat dissipation of the light emission component. A first carrying surface 911d and a second carrying surface 913d are formed at one side of the protrusion 914d, respectively. A third carrying surface 912d and a fourth carrying surface 915d is formed at other side of the protrusion 914d, respectively.

In some embodiments, the AWG may be placed horizontally on the corresponding carrying surface. For example, the first AWG 511e is placed horizontally on the first carrying surface 911d, and the second AWG 521e is placed horizontally on the third carrying surface 912d. Since lights exit horizontally from the first AWG 511e and the second AWG 521e, it is necessary to provide light path turning devices (e.g., turning prisms) to turn the optical paths of optical signals output by the AWGs, to transmit the optical signals to the surface of the light reception chips. Based on this, a first turning prism 512e is disposed on the surface of the second carrying surface 913d to turn the optical path of the optical signal output by the first AWG 511e, and a second turning prism 522e is disposed on the surface of the fourth carrying surface 915d to turn the optical path of the optical signal output by the second AWG 521e. In order to achieve matching of heights of the optical paths, the surface of the second carrying surface 913d is lower than the surface of the first carrying surface 911d, and the surface of the fourth carrying surface 915d is lower than the surface of the third carrying surface 912d.

In order to transmit the optical signals output by the AWGs to the surfaces of the light reception chips, a portion of the surface of the first turning prism 512e is mounted on the surface of the circuit board 300, while the other portion thereof is suspended, to transmit the optical signal from the first turning prism 512e to the surface of the light reception chip. The second turning prism 522e is also provided in this way. In some embodiments, in order to facilitate to limit the first turning prism 512e and the second turning prism 522e, respectively, an end face of the protrusion 914d is flush with the end face of the second carrying surface 913d and the end face of the fourth carrying surface 915d, respectively.

In order to make way for connecting components between AWG chips and capillaries of the AWGs, a first limiting portion 919d is formed on the surface of the first carrying surface 911d, and a second limiting portion 918d is formed on the surface of the third carrying surface 912d, to make way for the connecting components, respectively. For example, the connecting components may be adhesive.

In order to limit and secure the AWGs, a fencing portion 917d is formed on a side of the first carrying surface 911d, and a fencing portion 916d is formed on a side of the third carrying surface 912d to provide a fence having a height for the first AWG 511e and the second AWG 521e, respectively, thereby achieving the limiting and securing of the AWGs.

FIG. 29 is a schematic assembly diagram of yet another light reception component provided according to some embodiments of this disclosure, and FIG. 30 is a structural schematic diagram of yet another light reception component provided according to some embodiments of this disclosure. As shown in FIG. 29 and FIG. 30, in some embodiments, taking the base being the base 900e as an example, the base 900e is electrically connected to the circuit board 300, and the surface of the base 900e is provided with a light reception component 500f.

As mentioned above, the upper surface of the base 900e protrudes upwards to form a protrusion 914e. The protrusion 914e may contact the upper shell part to achieve heat dissipation of the light emission component. A first carrying surface 911e and a second carrying surface 912e are formed at one side of the protrusion 914e, respectively. For example, in order to facilitate limiting optical elements, end faces of the first carrying surface 911e and the second carrying surface 912e may be flush with an end face of the protrusion 914e. The surface of the protrusion 914e protrudes relative to the first carrying surface 911e and the second carrying surface 912e.

In order to achieve reception of optical signals, parts of optical elements of the first light reception component are disposed on the surface of the first carrying surface 911e, and parts of optical elements of the second light reception component are disposed on the surface of the second carrying surface 912e. In some embodiments, parts of optical elements of the first light reception component include a first fiber collimator 511f, a first converging lens 512f, a first optical demultiplexing component 513f, a first collimating lens 514f, and a first turning prism 515f. In addition to the aforementioned optical elements, the first light reception component further includes a light reception chip disposed on the surface of the circuit board 300. For example, the light reception chip is arranged in an array on the surface of the circuit board 300. An external optical signal is transmitted through the first fiber collimator 511f into the first light reception component, the optical signal is converged by the first converging lens 512f and then is transmitted to the first optical demultiplexing component 513f. After being demultiplexed by the first optical demultiplexing component 513f, the optical signal is divided into multiple paths of optical signals. The multiple paths of optical signals are collimated by the first collimating lens 514f, and then are transmitted to the first turning prism 515f. The first turning prism 515f is configured to adjust the optical path of each optical signal from a direction parallel to the surface of the circuit board 300 to a direction perpendicular to the surface of the circuit board 300, thereby transmitting each path of optical signal to the light reception chip disposed on the surface of the circuit board 300. Similarly, parts of optical elements of the second light reception component include a second fiber collimator 521f, a second converging lens 522f, a second optical demultiplexing component 523f, a second collimating lens 524f, and a second turning prism 525f. In addition to the aforementioned optical elements, the second light reception component further includes a light reception chip disposed on the surface of the circuit board 300. For example, the light reception chip is also arranged in an array on the surface of the circuit board 300. The optical path principle of the second light reception component is similar to that of the first light reception component, and thus will not be described in details herein.

It can be understood that the technical features of the light reception components disclosed in the above-mentioned embodiments can be referred to with each other, and as for anything not described in detail, reference may be made to the relevant contents of the other light reception components.

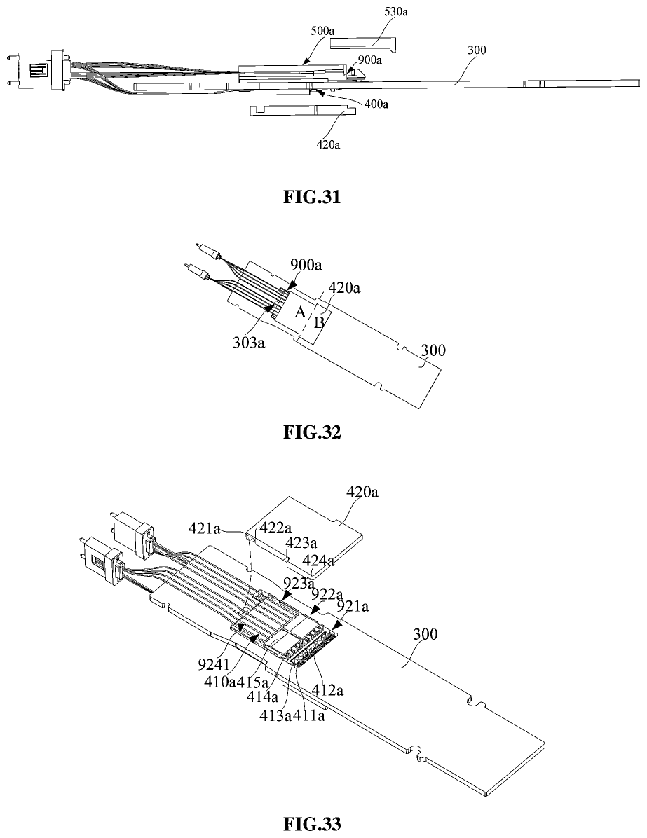

FIG. 31 is a schematic assembly diagram of a light emission component provided according to some embodiments of this disclosure, and FIG. 32 is a top assembly diagram of a light emission component provided according to some embodiments of this disclosure. As shown in FIG. 31 and FIG. 32, in some embodiments, taking the base being the base 900a as an example, the light reception component 500a is disposed on one surface of the base 900a, and the light emission component 400a is disposed on the other surface of the base 900a. For example, the light reception component 500a and the light emission component 400a are arranged one above another. In some embodiments, the upper surface of the base 900a is covered with a first protective cover, and the lower surface thereof is covered with a second protective cover. For example, the surface of the light reception component 500a is covered with a first protective cover 530a to protect the optical elements of the light reception component 500a. The surface of the light emission component 400a is covered with a second protective cover 420a to protect the optical elements of the light emission component 400a.

From a top-down perspective, the second protective cover 420a may be regarded as being divided into a first zone and a second zone. The first zone is shown as zone A in FIG. 32, and the second zone is shown as zone B in FIG. 32. A width of the circuit board corresponding to the zone A is relatively small, and thus the width of zone A is smaller than that of zone B, to ensure the contact area between zone A and the circuit board, thereby ensuring an adequate amount of the adhesive for the second protective cover 420a at the zone A, and ensuring that the second protective cover 420a is securely fixed.

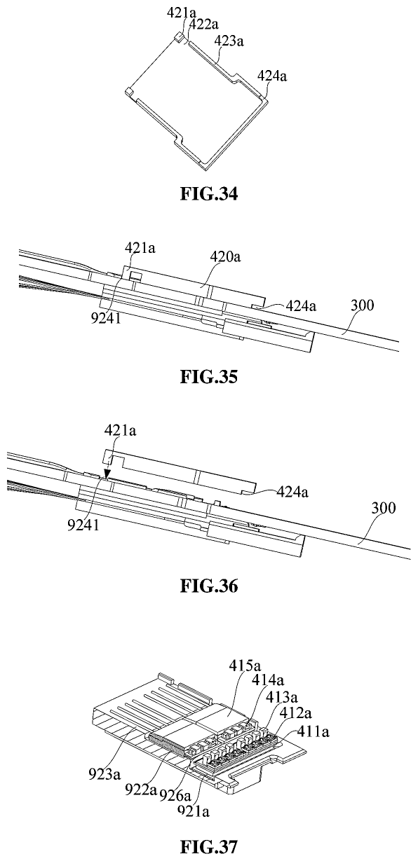

FIG. 33 is an exploded assembly diagram of a light emission component provided according to some embodiments of this disclosure, and FIG. 34 is a structural diagram of a second protective cover of a light emission component provided according to some embodiments of this disclosure. As shown in FIG. 33 and FIG. 34, in some embodiments, the lower surface of the base 900a is formed with a third carrying surface 921a, a fourth carrying surface 922a, and a fifth carrying surface 923a, respectively. For example, the third carrying surface 921a is configured to install a laser group 412a of the optical emission component. A TEC 411a is provided below the laser group 412a, the laser group 412a is stacked on the TEC 411a to have a height. The provision of the third carrying surface 921a causes the laser group 412a to sink so as to be flush with the surface of the circuit board 300, thereby ensuring that a wire bonding length between the laser group 412a and the surface of the circuit board 300 is shorter. The fourth carrying surface 922a is configured to carry the light emission passive device. For example, the light emission passive device may be an optical fiber array, an optical multiplexing component, an AWG, or the like. In the case that the optical emission passive device is the optical fiber array, the surface of the fifth carrying surface 923a is configured to place fiber pigtails. For example, the fourth carrying surface 922a carries the optical fiber array 415a, and the fifth carrying surface 923a carries the fiber pigtails.

In some embodiments, in order to improve optical coupling efficiency, a lens group 413a is provided between the optical fiber array 415a and the laser group 412a such that the optical signals are converged and then are output.

In some embodiments, in order to avoid interference caused by the contact of the second protective cover 420a with the light emission component, especially with the fiber pigtails. The fifth carrying surface 923a is formed with first supporting portions 924a on both sides thereof. Meanwhile, the fourth carrying surface 922a may also be formed with second supporting portions 925a on both sides thereof. With the first supporting portions 924a and the second supporting portions 925a, the protective cover may be disposed at a height, so as to provide a gap between the protective cover and the light emission component, thereby avoiding their interference with each other.

One end of the second protective cover 420a is formed with an insertion portion 421a, and the other end thereof is formed with an avoidance portion 424a. A sidewall 423a is also formed in the middle portion of the second protective cover 420a, with a notch 422a being formed between the insertion portion 421a and the sidewall 423a.

In order to secure the protective cover to the base 900a, each first supporting portion 924a is formed with a recess 9241, and the protective cover is disposed in the recess 9241, thereby securing the protective cover to the base 900a. Of course, it is also possible to use other structures for securing the protective cover. For example, the second protective cover 420a is formed with an insertion portion 421a which is inserted into the recess 9241 to secure the protective cover to the base 900a.

Sidewalls 423a on both sides of the second protective cover 420a enclose the first supports 924a and the second supports 925a, respectively, so as to cover the base 900a with the second protective cover 420a.

It can be seen from FIG. 34 that the size of the insertion portion 421a in a width direction of the second protective cover 420a is different from that of the sidewall 423a in the width direction of the second protective cover 420a. Therefore, an internal chamfer would be formed at an intersection of the insertion portion 421a and the sidewall 423a during the machining, which would interfere with the base 900a. Accordingly, the notch 422a is formed between the insertion portion 421a and the sidewall 423a to remove the internal chamfer formed by machining and avoid interference between the second protective cover 420a and the base 900a.

A high-frequency signal line is provided between the laser group 412a and the DSP chip disposed on the surface of the circuit board 300, to transmit electrical signals from the DSP chip to the laser group 412a. The dielectric constant of the second protective cover 420a is different from that of air, and specifically the dielectric constant of the second protective cover 420a is larger than that of air. If the surface of the high-frequency signal line comes into contact with the second protective cover 420a, the impedance of the high-frequency signal line at an intersection with the second protective cover 420a will decrease due to the negative correlation between impedance and dielectric constant, reducing the transmission performance of the high-frequency signal. Therefore, an avoidance portion 424a is formed at the other end of the second protective cover 420a, to keep the second protective cover 420a away from the high-frequency signal line as far as possible, thereby reducing an impact on the impedance of the high-frequency signal line.

In some embodiments, isolators are provided to prevent the optical signals emitted by the laser group 412a from returning to the laser group 412a and affecting the quality of the optical signals. For example, the isolators 414a are disposed between the optical fiber array 415a and the laser group 412a. Correspondingly, in order to install the isolators, a sixth carrying surface 926a is formed between the fourth carrying surface 922a and the third carrying surface 921a. The sixth carrying surface 926a is configured to install the isolators 414a.

As mentioned above, in order to achieve the matching of optical paths, the surface of the sixth carrying surface 926a is higher than that of the fourth carrying surface 922a, which may also function to limit the optical fiber array 415a in a first direction. For example, the first direction may be a length direction of the protrusion 910a. In order to limit the optical fiber array 415a in a second direction, the surfaces of the sixth carrying surface 926a at both sides thereof may be recessed downwards, such that a width of a protruded surface portion of the sixth carrying surface 926a is the same as the width of the optical fiber array 415a, thereby limiting the optical fiber array 415a in the second direction. For example, the second direction may be a width direction of the protrusion 910a.

FIG. 35 is a side assembly diagram of a light emission component provided according to some embodiments of this disclosure, and FIG. 36 is a side exploded assembly diagram of a light emission component provided according to some embodiments of this disclosure. As shown in FIG. 35 and FIG. 36, in some embodiments, one end of the second protective cover 420a is formed with an insertion portion 421a, and the base 900a is formed with a recess 9241. The insertion portion 421a is inserted into the recess 9241, thereby secure the protective cover to the base 900a.

An avoidance portion 424a is formed at the other end of the second protective cover 420a, to keep the second protective cover 420a as far away from the high-frequency signal line as possible, thereby reducing the impact on the impedance of the high-frequency signal line and ensuring the transmission performance of the high-frequency signal.

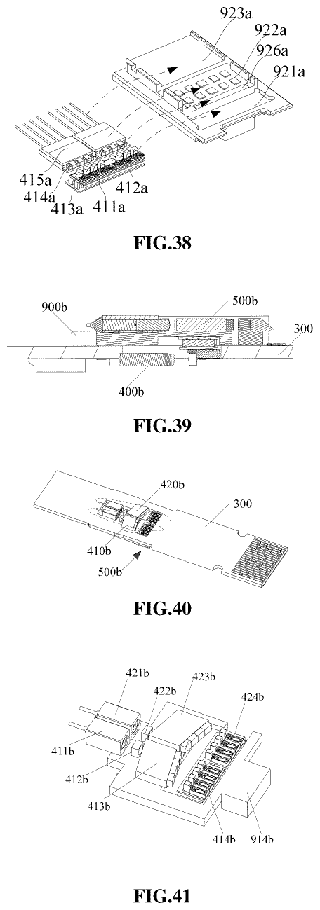

FIG. 37 is a sectional structural diagram of a light emission component provided according to some embodiments of this disclosure, and FIG. 38 shows an exploded structural diagram of a light emission component provided according to some embodiments of this disclosure. As shown in FIG. 37 and FIG. 38, in some embodiments, the lower surface of the base 900a is formed with a third carrying surface 921a, a fourth carrying surface 922a, and a fifth carrying surface 923a. For example, the third carrying surface 921a is configured to install the TEC 411a of the optical emission component as well as the laser group 412a and lens group 413a respectively disposed on the surface of TEC 411a. The third carrying surface 921a causes the laser group to sink, such that the surface of each laser is flush with the surface of the circuit board 300, thereby ensuring that a wire bonding length between each laser and the surface of the circuit board 300 is shorter, and improving the transmission performance of the high-frequency signal. In the case that the fourth carrying surface 922a carries the optical fiber array 415a, the fifth carrying surface 923a carries the fiber pigtails. In some embodiments, the fifth carrying surface 923a, the fourth carrying surface 922a and the third carrying surface 921a are arranged in a stepped manner, and surface heights of these three surfaces are sequentially reduced to achieve the matching of heights of the optical paths.

For example, the light emission passive device (e.g., the optical fiber array) can be mounted on the fourth carrying surface 922a by adhesive. When a stress generated during adhesive bonding is too concentrated, it would cause the bottom surface of the optical fiber array 415a to fracture. Therefore, in order to avoid stress concentration, protrusions 927a are formed at intervals on the surface of the fourth carrying surface 922a. The protrusions 927a are disposed at intervals so as to disperse the stress generated by the adhesive, thereby avoiding excessive concentration of the stress generated by the adhesive and ensuring an undamaged mounting of the optical fiber array 415a.

FIG. 39 is a sectional assembly diagram of another light emission component provided according to some embodiments of this disclosure. As shown in FIG. 39, in some embodiments, taking the base being the base 900b as an example, the circuit board 300 is provided with a base mounting portion 303, and the base 900b is located above the base mounting portion 303. The light reception component 500b is located above the base 900b, and the light emission component 400b is located below the base 900b.

FIG. 40 is a schematic assembly diagram of another light emission component provided according to some embodiments of this disclosure, FIG. 41 is a structural schematic diagram of another light emission component provided according to some embodiments of this disclosure, and FIG. 42 is a sectional structural diagram of another light emission component provided according to some embodiments of this disclosure. As shown in FIGS. 40-42, in order to achieve an emission of multi-path optical signals, the optical emission component 400b includes a first optical emission component 410b and a second optical emission component 420b. The first optical emission component 410b includes a first optical fiber splice 411b, a first converging lens 412b, a first multiplexer 413b, and a first optical emission assembly 414b. The first optical fiber splice 411b, the first converging lens 412b and the first multiplexer 413b are located on the lower surface of the base 900b. The first light emission assembly 414b is located in a first recess 915b, and a semiconductor refrigerator 417 is provided above the first light emission assembly 414b. The first recess 915b causes the lower surface of the first light emission assembly 414b to be flush with the lower surface of the circuit board 300, reducing a wire bonding distance between the first light emission assembly 414b and the circuit board 300.

The first light emission assembly 414b is electrically connected to the circuit board 300, and converts multi-path electrical signals into multi-path optical signals and to form collimated lights. The first multiplexer 413b multiplexes the multi-path optical signals into a beam of signal light having multiple wavelengths. The signal light having multiple wavelengths is converged through the first converging lens 412b to the first optical fiber splice 411b and then enters the optical fiber, thereby achieving a soft connection between the optical emission component and the optical fiber adapter at the optical port of the module. The first optical fiber splice 411b is provided therein with an optical isolator, which simplifies the assembly process while reducing costs.

In some embodiments, the lasers of the first light emission assembly 414b of the first emission component emit four scattered lights of different wavelengths, which are collimated by the collimating lens into four parallel beams. The four beams are combined into one beam by the first wavelength division multiplexer, and then enters the first converging lens 412b and is formed into a converged light, which then enters the first optical fiber splice 411b. A distance between the first converging lens and the first optical fiber splice corresponds to a focal length of the converging lens.

In the light reception component, the light output from the first collimator is a collimated beam, which is demultiplexed into four beams by the first demultiplexer, and then the four beams are converged into four converged beams by the first lens assembly, and the direction of the light path is turned to a direction facing the surface of the circuit board. Therefore, a length of optical path from the laser to the first optical fiber splice in the first light emission component is larger than a length of optical path from the light reception chip to the first optical collimator in the first light reception component.

In some embodiments of this application, a region between the first notch 911b and the second notch 912b of the carrying plate 916b protrudes, relative to the sidewall of the base 900b, towards the optical port. The carrying plate 916b is configured to carry the optical fiber splice. The first optical fiber splice is connected to the carrying plate 916b.

The second optical emission component 420b includes a second optical fiber splice 421b, a second converging lens 422b, a second multiplexer 423b and a second optical emission assembly 424b. The second optical fiber splice 421b, the second converging lens 422b, and the second multiplexer 423b are located on the lower surface of the base 900b. The second light emission assembly 424b is located in the first recess 915b, and a semiconductor refrigerator 417 is also provided above the second light emission assembly 424b. The first recess 915b causes the lower surface of the second light emission assembly 424b to be flush with the lower surface of the circuit board 300, thereby reducing a wire bonding distance between the second light emission assembly 424b and the circuit board 300. The second optical fiber splice is connected to the carrying plate 916b.

In some embodiments of this application, the protrusion 914b is thermally connected to the upper shell part. The first and second light emission assemblies are main heat sources of the light module, the heat dissipated by them is transferred to the upper shell part through the protrusion 914b, thereby improving the heat dissipation effect of the light module.

In some embodiments, the first optical fiber adapter is connected with the first optical fiber splice, and the second optical fiber adapter is connected with the second optical fiber splice. The third optical fiber adapter is connected with the first optical collimator, and the fourth optical fiber adapter is connected with the second optical collimator.

The first optical emission component includes four lasers, and the second optical emission component includes four lasers. The first wavelength division multiplexer combines lights emitted from the four lasers of the first optical emission component into one beam, which is sent out through the first optical fiber adapter. The second wavelength division multiplexer combines the lights emitted from the four lasers of the second optical emission component into one beam, which is sent out through the second optical fiber adapter.

The light beam carried within the third optical fiber adapter is divided into four beams by the first demultiplexer, and the four beams are received by four light reception chips. The light beam carried within the fourth optical fiber adapter is divided into four beams by the second demultiplexer, and the four beams are received by four light reception chips.

In some embodiments, the first optical fiber adapter, the third optical fiber adapter, the second optical fiber adapter, and the fourth optical fiber adapter may be arranged sequentially at the same height. Alternatively, they may be arranged in two rows, for example, such that the first optical fiber adapter and the third optical fiber adapter are located above the second optical fiber adapter and the fourth optical fiber adapter, respectively.

The base mounting portion 303 provides space for the installation of light emission components.

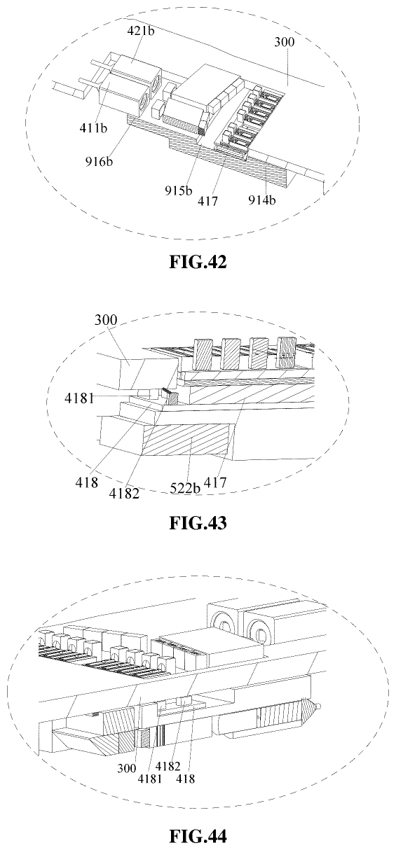

FIG. 43 is a first partial sectional structural schematic diagram of an optical module provided according to some embodiments of this application, and FIG. 44 is a second partial sectional structural schematic diagram of an optical module provided according to some embodiments of this application. As shown in FIG. 43 and FIG. 44, a hot side of semiconductor refrigerator 417 is connected with positive and negative power supply wires, which are led out from a third notch 913b; and the upper surface of the circuit board is provided with conductive pins, such that the positive and negative power supply wires are connected with conductive pins. In some embodiments, the conductive pins are located at the third notch 913b, and the conductive pins are located above the power supply wires. The hot side of the semiconductor refrigerator is a side adjacent to the light emitting chip.

A substrate 418 is provided between the semiconductor refrigerator 417 and the first recess 915b, and the substrate is provided with a circuit electrically connected to other parts of the semiconductor refrigerator 417. One end of the substrate 418 is inserted into the third notch and below the circuit board 300. The hot side of the semiconductor refrigerator is connected with the positive and negative power supply wires. The upper surface of the circuit board is provided with the positive and negative pins. The third notch 913b causes the positive power supply wire 4181 and the negative power supply wire 4182 to be led out under the circuit board. The positive pin is electrically connected with the positive power supply wire, while the negative pin is electrically connected with the negative power supply wire.

This application provides an optical module with a circuit board provided with a base mounting portion, parts of which are covered by a base. The base is disposed on a lower surface of the circuit board. An upper surface of the base 900b protrudes to form a protrusion 914b, with a first light reception component and a second light reception component located at both sides of the protrusion 914, respectively. A lower surface of the base 900b is recessed to form a first recess 915b, and the lower surface of the base 900b is in contact and connected with the upper surface of the circuit board. A bottom surface of the first recess 915b is recessed relative to a bottom surface of the base 900b so as to minimize electrical connection wires between the light emission component and the circuit board. The base 900b is also formed with a third notch 913b, and the first recess 915b is communicated with the third notch 913b, thereby facilitating observation and positioning through the third notch 913b during installation.

In this application, a first optical chipset 514b, a first transimpedance amplifier 515b, a second optical chipset 524b and a second transimpedance amplifier 525b are stationary on the circuit board. During the installation process, the base, the first optical emission component, and the second optical emission component may be firstly connected, and then the first optical collimator, the first demultiplexer, the second optical collimator, and the second demultiplexer may be connected to the base, to form a transceiver device. The base provides an installation platform for the first optical emission component, the second optical emission component, the first optical collimator, the first demultiplexer, the second optical collimator and the second demultiplexer. Then, the transceiver device is positioned on and connected to the circuit board, and first and second lens components are installed according to a position relationship between the base and the circuit board.

The base, the first optical emission component and second optical emission component are connected, and then the first optical collimator, first demultiplexer, second optical collimator, and second demultiplexer are connected with the base, to form the transceiver device. The transceiver device, as a whole, is easy to install and may be applied to various optical modules.

The light emission component is designed to be reversely assembled, such that, during assembly, a wire bonding surface of the light emission component is at the same level as the lower surface of the circuit board, thereby minimizing a wire bonding length between them and ensuring excellent high-frequency transmission performance. The light emission component is designed to be reversely assembled, the base also serves as a radiator for the lasers and the semiconductor refrigerator, and directly in contact with the upper cover plate of the light module, thereby forming a more direct and efficient heat transfer channel.

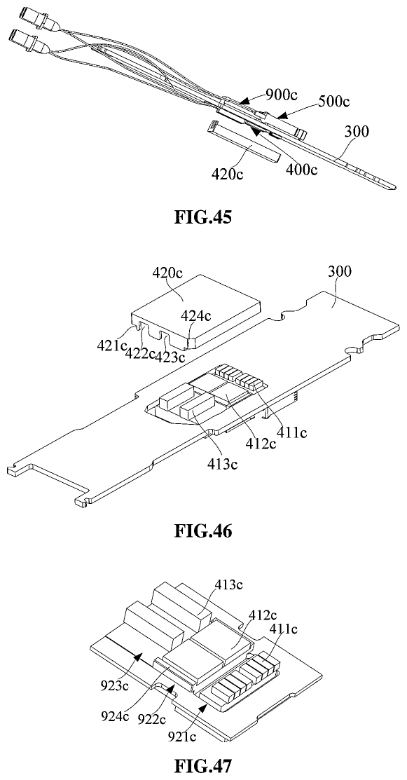

FIG. 45 is a first schematic assembly diagram of yet another light emission component provided according to some embodiments of this disclosure, FIG. 46 is a second schematic assembly diagram of yet another light emission component provided according to some embodiments of this disclosure. As shown in FIG. 45 and FIG. 46, in some embodiments, taking the base being the base 900c as an example, the light reception component 500c is disposed on one surface of the base 900c, and the light emission component 400c is disposed on the other surface of the base 900c.

In some embodiments, the surface of the light emission component 400c is covered with a second protective cover 420c to protect optical elements of the light emission component 400c. The second protective cover 420c includes a first overlapping portion 421c, a first avoidance gap 422c, a second avoidance gap 423c and a second overlapping portion 424c which are disposed sequentially. The first overlapping portion 421c and the second overlapping portion 424c are respectively overlapped on the surface of the circuit board, thereby securing the second protective cover 420c to the surface of the circuit board 300. The first avoidance gap 422c and the second avoidance gap 423c are configured to avoid (in other words, to make way for) part structures of the light emission component 400c.

In some embodiments, the optical emission component 400c includes a laser group, an optical emission passive device for beam combination, and an optical emission passive device for transmission. For example, the light emission passive device for beam combination may be an optical multiplexing component or the like, and the light emission passive device for transmission may be a fiber collimator or the like.

In some embodiments, the optical emission component 400c includes a laser group 411c, an optical multiplexing component 412c and a fiber collimator 413c. The laser group 411c includes several lasers, and multi-path optical signals generated by the laser group 411c are transmitted to the optical multiplexing component 412c and are combined by the optical multiplexing component 412c, and then the multiplexed beam is transmitted to the fiber collimator 413c, which then output the beam. For example, the laser group 411c corresponds to two optical multiplexing components 412c, respectively, with one optical multiplexing component 412c corresponding to one fiber collimator 413c. Multiple beams of optical signals emitted by the laser group 411c are combined into two beams of optical signals through the two optical multiplexing components 412c, and then each combined beam is transmitted through one fiber collimator 413c. In some embodiments, a surface of each laser of the laser group 411c is flush with the surface of the circuit board to shorten a wire bonding length between them, and thus improve a high-frequency signal transmission performance. Meanwhile, in this case, for example, the first avoidance gap 422c is configured to make way for one of the fiber collimators 413c, and the second avoidance gap 423c is configured to make way for the other one of the fiber collimators 413c.

FIG. 47 is a structural schematic diagram of yet another light emission component provided according to some embodiments of this disclosure. As shown in FIG. 47, in some embodiments, one surface of the base 900c is configured to carry the light reception component, and the other surface thereof is configured to carry the light emission component. For example, the lower surface of the base 900c is used to install the light emission component. The lower surface of the base 900c is formed with a fourth carrying surface 921c, a fifth carrying surface 922c, and a sixth carrying surface 923c, and the fifth carrying surface 922c is disposed between the fourth carrying surface 921c and the sixth carrying surface 923c.

For example, the fourth carrying surface 921c is configured to dispose the laser group 411c for emitting multi-path optical signals, the fifth carrying surface 922c is configured to dispose the optical multiplexing component 412c for combining the multi-path optical signals, and the sixth carrying surface 923c is configured to dispose the fiber collimator 413c for transmitting the combined optical signal.

In order to limit and secure the optical multiplexing components 412c, limiting portions 924c are formed on both sides of the fifth carrying surface 922c. The surface of the limiting portion 924c is protruded relative to the surface of the fifth carrying surface 922c. A structure of the limiting portion 924c may be a limiting boss, thereby limiting and securing the light multiplexing element 412c.

In some embodiments, the circuit board 300 may be embedded in the surface of the base 900a to be relatively closer to the laser group 411c. The surface of the fourth carrying surface 921c is depressed relative to the surface of the fifth carrying surface 922c to cause the laser group 411c to sink, such that the surface of the laser group 411c is flush with the surface of the circuit board 300, thereby shortening a wire bonding length between the them, and improving the transmission performance. In some embodiments, a height difference between the fifth carrying surface 922c and the sixth carrying surface 923c is made to match the height of optical path of the optical multiplexing component 412c with that of the fiber collimator 413c.

It can be understood that, the light reception component working with the light emission component 400c may be the above-mentioned light reception component 500c, the light reception component 500d, the light reception component 500e, or the light reception component 500f.

The above-mentioned embodiments of this disclosure do not constitute any limitation to the protection scope of this disclosure.

What is claimed is:

1. An optical module, comprising:
an upper shell part;
a circuit board formed, on a surface thereof, with a base mounting portion;
a base secured to the surface of the circuit board through the base mounting portion, an upper surface of the base being formed with a protrusion protruded towards the upper shell part and in thermal connection with the upper shell part;
a light reception component located on an upper surface of the base and at a side of the protrusion, to receive multi-path optical signals; and
a light emission component located on a lower surface of the base, to emit multi-path optical signals.

2. The optical module according to claim 1, wherein,
a light reception chip array is disposed on the surface of the circuit board, and opposite sides of the protrusion are each provided with the light reception component;
a first carrying surface and a first extension portion located at an end of the first carrying surface are formed at one side of the protrusion, and a second carrying surface and a second extension portion located at an end of the second carrying surface are formed at the other side of the protrusion; and a third carrying surface and a fourth carrying surface are formed on the lower surface of the base, and wherein
a first light reception passive device is located on the first carrying surface for receiving multi-path optical signals;
a second light reception passive device is located on the second carrying surface for receiving multi-path optical signals;
a first optical path turning device is located on a surface of the first extension portion, for changing a transmission direction of multi-path optical signals output by the first light reception passive device, such that the multi-path optical signals from the first light reception passive device are transmitted to the light reception chip array;
a second optical path turning device is located on a surface of the second extension portion, for changing a transmission direction of multi-path optical signals output by the second light reception passive device, such that the multi-path optical signals output from the second light reception passive device are transmitted to the light reception chip array;
a laser group is located on a surface of the third carrying surface, for emitting multi-path optical signals; and
a light emission passive device is located on a surface of the fourth carrying surface, for processing the multi-path optical signals emitted by the laser group.

3. The optical module according to claim 2, wherein extension lengths of the first and second extension portions are designed to enable the light reception chip array to be exposed;
the first optical path turning device is disposed on the surface of the first extension portion via a first substrate, and the first substrate has an extension length longer than the extension length of the first extension portion such that the first optical path turning device is extended to a surface of the light reception chip array; and
the second optical path turning device is disposed on the surface of the second extension portion via a second substrate, and the second substrate has an extension length longer than the extension length of the second extension portion such that the second optical path turning device is extended to the surface of the light receiving chip array.

4. The optical module according to claim 2, wherein a first limiting tab is formed between the first carrying surface and the first extension portion, a surface of the first limiting tab being higher than the surface of the first carrying surface so as to limit the first light reception passive device; and a second limiting tab is formed between the second carrying surface and the second extension portion, a surface of the second limiting tab being higher than the surface of the second carrying surface so as to limit the second reception passive device.

5. The optical module according to claim 2, wherein
a first depression is formed at one end of the first carrying surface facing towards the first extension portion; and a second depression is formed at one end of the second carrying surface facing towards the second extension portion; and
the surface of the first extension portion is lower than the surface of the first carrying surface, the surface of the second extension portion is lower than the surface of the second carrying surface, and a notch is formed between the first extension portion and the second extension portion.

6. The optical module according to claim 3, wherein each of the first substrate and the second substrate is formed with a light hole to transmit light output from a corresponding one of the first and second optical path turning devices to a corresponding surface of the light receiving chip array.

7. The optical module according to claim 1, wherein the base comprises:
a first recess located on the lower surface of the base and is concave upwards relative to the base; a semiconductor refrigerator is disposed in the first recess, a hot side of the semiconductor refrigerator being provided with power supply wires; and an upper surface of the circuit board is provided with conductive pins which are connected to the power supply wires; and
a third notch is formed on one side of the base, the third notch being communicated with the first recess.

8. The optical module according to claim 1, wherein the light reception component comprises:
a first optical collimator;
a first demultiplexer, wherein the first optical collimator and the first demultiplexer are located on the upper surface of the base and at one side of the protrusion;
a second optical collimator; and
a second demultiplexer, wherein the second optical collimator and the second demultiplexer are located on the upper surface of the base and at the other side of the protrusion.

9. The optical module according to claim 8, further comprising a first lens component,
wherein one end of the protrusion is protruded from a sidewall of the base, and the first lens component is located at one side of the protrusion.

10. The optical module according to claim 7, wherein the light emission component comprises:
a first light emission assembly located below the semiconductor refrigerator;
a first multiplexer located on the lower surface of the base, to multiplex light emitted from the first light emission assembly;
a first converging lens located on the lower surface of the base and in a light exiting direction of the first multiplexer; and
a first optical fiber splice having a built-in optical isolator, the first optical fiber splice being connected with an optical fiber; and
wherein the base is provided with a carrying plate which is connected to the first optical fiber splice.

11. The optical module according to claim 10, wherein
a first notch and a second notch are respectively provided on either side of the carrying plate;
the light reception component comprises a first optical collimator and a second optical collimator; and
a side edge of the first notch functions to limit the first optical collimator, and a side edge of the second notch functions to limit the second optical collimator.

12. The optical module according to claim 1, wherein a first carrying surface, a second carrying surface and a third carrying surface are formed at different sides of the protrusion, the second carrying surface being located at a side opposite to the first carrying surface, the third carrying surface being located adjacent to the first carrying surface; and the lower surface of the base is formed with a fourth carrying surface and a fifth carrying surface;
a first light reception passive device is located on a surface of the first carrying surface, an end face of a light exiting end of the first light reception passive device being erected on the surface of the first carrying surface, and the light exiting end of the first light reception passive device having no reflective surface;
a second light reception passive device is located on a surface of the second carrying surface, an end face of a light exiting end of the second light reception passive device being erected on the surface of the second carrying surface, and the light exiting end of the second light reception passive device having no reflective surface;
a first reflective surface is disposed in an optical path output from the first light reception passive device, for reflecting an optical signal output from the first light reception passive device;
a second reflective surface is disposed on an optical path output from the second reception passive device, for reflecting an optical signal output from the second light reception passive device;
a first optical path turning device is disposed at one end of the third carrying surface, for changing a transmission direction of optical signal reflected via the first reflective surface such that the optical signal from the first reflective surface is transmitted to the light reception chip array;
a second optical path turning device is disposed at the other end of the third carrying surface, for changing a transmission direction of optical signal reflected via the second reflective surface such that the optical signal from the second reflective surface is transmitted to the light reception chip array;
a laser group is located on the surface of the fourth carrying surface, for emitting multi-path optical signals; and
a light emission passive device is located on a surface of the fifth carrying surface, for combining and transmitting the multi-path optical signals emitted by the laser group.

13. The optical module according to claim 12, wherein
a first lens is provided between the optical path output from the first light reception passive device and the first reflective surface, one end of the first lens being provided at one end of the third carrying surface, and the other end of the first lens being used to carry the first reflective surface; and
a second lens is provided between the optical path output from the second optical reception passive device and the second reflective surface, one end of the second lens being provided at the other end of the third carrying surface, and the other end of the second lens being used to carry the second reflective surface.

14. The optical module according to claim 12, wherein one end of the first optical path turning device is connected to a sidewall of the protrusion, and the other end of the first optical path turning device is suspended; and one end of the second optical path turning device is connected to the sidewall of the protrusion, and the other end of the second optical path turning device is suspended.

15. The optical module according to claim 12, wherein the first light reception passive device comprises a first AWG, and the second light reception passive device comprises a second AWG; and a light exiting end face of the first AWG and a light exiting end face of the second AWG are planar; and
the light exiting end face of the first AWG faces towards the first reflective surface, and the light exiting end face of the second AWG faces towards the second reflective surface.

16. The optical module according to claim 12, wherein the first optical path turning device comprises a first turning prism, and the second optical path turning device comprises a second turning prism, wherein
a light entering end of the first turning prism faces towards a light exiting end face of the first reflective surface, and a light exiting end of the first turning prism faces towards the light reception chip array; and
a light entering end of the second turning prism faces towards a light exiting end face of the second reflective surface, and a light exiting end of the second turning prism faces towards the light reception chip array.

17. The optical module according to claim 1, wherein a first carrying surface, a second carrying surface and a third carrying surface are formed at different sides of the protrusion, the second carrying surface being located at a side opposite to the first carrying surface, and the third carrying surface being located adjacent to the first carrying surface; and a fourth carrying surface and a fifth carrying surface are formed on the lower surface of the base;
a first light reception passive device is located on a surface of the first carrying surface, an end face of a light exiting end of the first light reception passive device is erected on the surface of the first carrying surface, and the light exiting end of the first light reception passive device is formed with a reflective surface;
a second light reception passive device is located on a surface of the second carrying surface, an end face of a light exiting end of the second light reception passive device is erected on the surface of the second carrying surface, and the light exiting end of the second light reception passive device is formed with a reflective surface;
a first optical path turning device is disposed at one end of the third carrying surface, for changing a transmission direction of multi-path optical signals output from the first light reception passive device such that the multi-path optical signals output from the first light reception passive device are transmitted to the light reception chip array;
a second optical path turning device is disposed at the other end of the third carrying surface, for changing a transmission direction of multi-path optical signals output from the second light reception passive device such that the multi-path optical signals output from the second light reception passive device are transmitted to the light reception chip array;
a laser group is located on a surface of the fourth carrying surface, for emitting multi-path optical signals; and
a light emission passive device is located on a surface of the fifth carrying surface, for combining and transmitting the multi-path optical signals emitted by the laser group.

18. The optical module according to claim 17, wherein the first light reception passive device comprises a first AWG, and the second light reception passive device comprises a second AWG, wherein
the reflective surfaces formed on light exiting ends of the first AWG and the second AWG are both inclined surfaces; and
end faces of the light exiting ends of the first AWG and the second AWG respectively face towards the first optical path turning device and the second optical path turning device.

19. The optical module according to claim 18, wherein a first lens is connected to the end face of the light exiting end of the first AWG, and is located between the end face of the light exiting end of the first AWG and the first optical path turning device; and a second lens is connected to the end face of the light exiting end of the second AWG, and is located between the end face of the light exiting end of the second AWG and the second optical path turning device.

20. The optical module according to claim 1, wherein a light reception chip array is disposed on a surface of the circuit board, and opposite sides of the protrusion are each provided with the light reception component;
a first carrying surface and a second carrying surface are formed at one side of the protrusion, and a third carrying surface and a fourth carrying surface are formed at the other side of the protrusion, wherein sidewalls of the first carrying surface and the third carrying surface are respectively formed with a fence; a surface of the second carrying surface is lower than a surface of the first carrying surface, and a surface of the fourth carrying surface is lower than a surface of the third carrying surface; and the base is provided, on a surface thereof, with:
a first AWG located on the surface of the first carrying surface, a light exiting end face of the first AWG being horizontally placed on the surface of the first carrying surface, the light exiting end face of the first AWG being planar;
a second AWG located on the surface of the third carrying surface, a light exiting end face of the second AWG being horizontally placed on the surface of the first carrying surface, and the light exiting end face of the second AWG being planar;
a first optical path turning device located on the surface of the second carrying surface, for changing a transmission direction of multi-path optical signals output by the first AWG such that the multi-path optical signals output by the first AWG are transmitted to the optical reception chip array; and
a second optical path turning device located on the surface of the fourth carrying surface, for changing a transmission direction of multi-path optical signals output by the second AWG such that the multi-path optical signals output by the second AWG are transmitted to the optical reception chip array.
